(19) United States
(12) Patent Application Publication
(10) Pub. No.: US 2025/0206067 A1
(43) Pub. Date: Jun. 26, 2025

(54) TIRE

(71) Applicant: SUMITOMO RUBBER INDUSTRIES, LTD., Kobe-shi, Hyogo (JP)

(72) Inventor: Takafumi NOGUCHI, Kobe-shi (JP)

(73) Assignee: SUMITOMO RUBBER INDUSTRIES, LTD., Kobe-shi, Hyogo (JP)

(21) Appl. No.: 18/843,441

(22) PCT Filed: Feb. 17, 2023
(86) PCT No.: PCT/JP2023/005735

§ 371 Date: Sep. 3, 2024

(30) Foreign Application Priority Data
Mar. 7, 2022 (JP) 2022-034507

(51) Int. Cl. B60C 11/03; B60C 1/00

(52) U.S. Cl. CPC B60C 11/03; B60C 1/0016; B60C 2011/0341

(57) ABSTRACT

The present disclosure provides a tire with an improved overall performance in terms of wet performance and dry performance. The present disclosure relates to a tire, including a tread with at least one circumferential groove, the circumferential groove being formed of a groove-forming rubber composition containing a rubber component and silica, tan δ when wet with water and tan δ when dry of the groove-forming rubber composition and a ratio Z of a largest groove depth D (mm) of the circumferential groove to a largest thickness T (mm) of the tread satisfying the following formulas (1) and (2):

tan δ when wet with water/tan δ when dry>1.00 (1)

Z≥0.10 (2)

where tan δ represents a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes, and Z represents the ratio D/T.

### TECHNICAL FIELD

The present disclosure relates to a tire.

### BACKGROUND ART

Addition of silica, for example, is proposed as a technique to improve the wet performance of tires. However, an improvement in wet performance (performance on a wet road surface) tends to reduce dry performance (performance on a dry road surface). There is a desire to achieve both these performances.

### SUMMARY OF DISCLOSURE

### Technical Problem

The present disclosure aims to solve the above problem and provide a tire with an improved overall performance in terms of wet performance and dry performance.

### Solution to Problem

The present disclosure relates to a tire, including a tread with at least one circumferential groove,
the circumferential groove being formed of a groove-forming rubber composition containing a rubber component and silica,
tan δ when wet with water and tan δ when dry of the groove-forming rubber composition and a ratio Z of a largest groove depth D (mm) of the circumferential groove to a largest thickness T (mm) of the tread satisfying the following formulas (1) and (2):

tan δ when wet with water/tan δ when dry>1.00 (1)

Z≥0.10 (2)

where tan δ represents a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes, and Z represents the ratio D/T.

### Advantageous Effects of Disclosure

The tire of the present disclosure includes a tread with at least one circumferential groove formed of a groove-forming rubber composition containing a rubber component and silica, and the tire satisfies the formulas (1) and (2). The tire can obtain an improved overall performance in terms of wet performance and dry performance.

### BRIEF DESCRIPTION OF DRAWINGS

FIG. 1 shows a meridional cross-sectional view of a part of a pneumatic tire 1 according to an embodiment of the present disclosure.

FIG. 2 shows a cross-sectional view of a tread portion 2 of the tire 1 cut along a plane including the tire axis.

### DESCRIPTION OF EMBODIMENTS

The tire of the present disclosure includes a tread with at least one circumferential groove. The circumferential groove is formed of a groove-forming rubber composition containing a rubber component and silica. The tire satisfies the formulas (1) and (2).

The mechanism for the advantageous effect is not completely clear, but it is assumed as follows.

When the rubber composition forming a circumferential groove of the tread (groove-forming rubber composition) has a tan δ when wet with water that is higher than the tan δ when dry thereof (formula (1)), the hysteresis friction with a road surface is improved to suppress a reduction in the grip performance, even if the conditions of the road surface change from dry to wet road surface. Thus, presumably, excellent dry performance is obtained and also good wet performance is maintained. At the same time, with regard to the circumferential groove formed on the tread, when the Z (=a ratio of the largest groove depth D of the circumferential groove to the largest thickness T of the tread) is controlled to be 0.10 or higher (formula (2)), the tread with the circumferential groove reliably has rigidity while obtaining good water drainage. Thus, presumably, good dry performance is maintained, and also the wet performance is improved.

Presumably, due to the above mechanism, the present disclosure significantly improves the overall performance in terms of wet performance and dry performance by satisfying the formulas (1) and (2).

The tire solves the problem (aim) in obtaining an improved overall performance in terms of wet performance and dry performance because of its structure in which the tan δ when wet with water and the tan δ when dry of the rubber composition forming the circumferential groove (groove-forming rubber composition) and the Z (=largest groove depth D (mm) of the circumferential groove/largest thickness T (mm) of the tread) satisfy the formula (1): tan δ when wet with water/tan δ when dry>1.00 and the formula (2): Z≥0.10. In other words, the parameters of the formula (1): tan δ when wet with water/tan δ when dry>1.00 and the formula (2): Z≥0.10 do not define the problem (aim). The problem herein is to obtain an improved overall performance in terms of wet performance and dry performance. In order to solve the problem, the tire has been formulated to satisfy the parameters.

Herein, the tan δ of the groove-forming rubber composition which is a cross-linkable groove-forming rubber composition means the tan δ of the groove-forming rubber composition after cross-linking. For example, the tan δ of a cross-likable rubber composition containing a diene-based rubber, sulfur, and the like means the tan δ of the vulcanized (cross-linked) rubber composition. The tan δ is a value determined by viscoelastic testing of a groove-forming rubber composition (a cross-linked groove-forming rubber composition in the case of a groove-forming rubber composition after cross-linking).

Herein, the term “tan δ when dry” means the tan δ of the groove-forming rubber composition which is dry and specifically refers to the tan δ of the groove-forming rubber composition (cross-linked tread in EXAMPLES) which has been dried by the method described in EXAMPLES.

Herein, the term “tan δ when wet with water” means the tan δ of the polymer composition which is wet with water and specifically refers to the tan δ of the groove-forming rubber composition (cross-linked tread in EXAMPLES) which has been wet with water by the method described in EXAMPLES.

Herein, the tan δ of the groove-forming rubber composition is a tan δ after 30 minutes from the start of measurement under the conditions of a temperature of 30° C., an initial strain of 10%, a dynamic strain of 1%, a frequency of 10 Hz, an elongation mode, and a measurement duration of 30 minutes.

The tire of the present disclosure includes a tread with at least one circumferential groove formed of a groove-forming rubber composition containing a rubber component and silica. The tan δ when wet with water and the tan δ when dry of the groove-forming rubber composition satisfy the following formula (1):

tan δ when wet with water/tan δ when dry>1.00 (1)

where tan δ represents a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes.

The value of “tan δ when wet with water/tan δ when dry” of the groove-forming rubber composition is preferably 1.05 or more, more preferably 1.07 or more, still more preferably 1.12 or more, further preferably 1.15 or more, particularly preferably 1.20 or more. The upper limit of the value of “tan δ when wet with water/tan δ when dry” is not limited, and it is preferably 1.80 or less, more preferably 1.60 or less, still more preferably 1.50 or less, further preferably 1.40 or less, further preferably 1.22 or less, further preferably 1.21 or less. When the value is within the range indicated above, the advantageous effect can be suitably achieved.

The tan δ when dry of the groove-forming rubber composition is preferably 0.10 or more, more preferably 0.15 or more, still more preferably 0.16 or more, particularly preferably 0.11 or more. The upper limit of the tan δ when dry is not limited, and it is preferably 0.50 or less, more preferably 0.40 or less, still more preferably 0.30 or less, particularly preferably 0.25 or less. When the tan δ when dry is within the range indicated above, the advantageous effect can be suitably achieved.

The tan δ when wet with water of the groove-forming rubber composition is preferably 0.11 or more, more preferably 0.16 or more, still more preferably 0.17 or more, further preferably 0.18 or more, further preferably 0.19 or more, further preferably 0.20 or more. The upper limit of the tan δ when dry is not limited, and it is preferably 0.55 or less, more preferably 0.45 or less, still more preferably 0.35 or less, particularly preferably 0.30 or less. When the tan δ is within the range indicated above, the advantageous effect can be suitably achieved.

When the formula (1): tan δ when wet with water/tan δ when dry>1.00 is satisfied, the loss tangent (tan δ) reversibly changes with water. Herein, the expression “the loss tangent (tan δ) reversibly changes with water” means that the tan δ of the (vulcanized) groove-forming rubber composition reversibly increases or decreases depending on the presence of water. It is sufficient that the tan δ reversibly changes when the state of the groove-forming rubber composition changes as follows: dry→wet with water→dry, for example. The groove-forming rubber composition in the former dry state may not have the same tan δ as that in the latter dry state or may have the same tan δ as that in the latter dry state.

The formula (1) of the (vulcanized) groove-forming rubber composition (for example, reversible change with water in tan δ represented by the formula (1)) can be actually satisfied by adding at least one component in which cross-links between the silica and the polymer are partly or fully formed by ionic bonds, for example.

Specifically, when an ionic coupling agent is further added to the silica and the polymer, ionic bonds can be formed between the polymer and the ionic coupling agent bound to the surface of the silica. Due to the reversibility of the ionic bonds, the cross-link between the silica and the polymer is cleaved only when wet with water, thereby increasing the mobility of the polymer from which the ionic bonds are dissociated. Therefore, in driving under water-wet conditions, energy loss is likely to occur in the inner part of the rubber, and a loss coefficient tan δ is enhanced. Thus, presumably, the improvement in the hysteresis friction with a road surface can suppress a reduction in the grip performance during the change from a dry to wet road surface. Meanwhile, the silica and the polymer are bound to each other in the rubber composition containing the above-described materials when dry, and the rubber composition can behave like a normal rubber. Thus, deterioration of dry performance such as rolling resistance can be prevented.

Presumably, the above-described mechanism improves the overall performance in terms of wet performance and dry performance.

The formula (1) can also be satisfied by adding a modified polymer that is hydrophilic and has been modified with an acid or a base and a surface-modified silica having a metal oxide and/or a basic molecule on its surface.

Specifically, for example, when a modified polymer such as a carboxylic acid-modified SBR and a surface-modified silica having a metal oxide and/or a basic molecule on its surface are used in combination, the anion derived from the carboxylic acid and the cation derived from the metal oxide or the basic molecule form an ionic bond between the modified polymer and the metal oxide and/or the surface-modified silica. Then, the ionic bond may be cleaved by adding water and re-formed by drying water. Consequently, the E* decreases and/or the tan δ increases when wet with water, while the E* increases and/or the tan δ decreases when dry. Presumably, the reversible change can be thus achieved.

Presumably, the above-described mechanism also improves the overall performance in terms of wet performance and dry performance.

The tan δ when dry can be controlled by the types and the amounts of chemicals (in particular, polymers, fillers, softening agents, resins, sulfur, and vulcanization accelerators) in the groove-forming rubber composition. For example, the tan δ when dry tends to be increased by using softening agents (e.g., resin) with low compatibility with polymers, using unmodified polymers, increasing the amount of fillers, increasing oils as plasticizers, reducing sulfur, or reducing vulcanization accelerators.

The tan δ when wet with water can be increased, as compared to the tan δ when dry, in the rubber composition in which the silica and the polymer are partly or fully cross-linked by ionic bonds using the ionic coupling agent or in the rubber composition in which the cross-links between the modified polymer and the metal oxide and/or the surface-modified silica are partly or fully formed by ionic bonds, for example. Thus, the tan δ when dry and when wet with water can be controlled. Specifically, the rubber composition including cross-linking by ionic bonds can increase the tan δ when wet with water as compared to the tan δ when dry. Moreover, the tan δ when wet with water can be controlled by varying the types or the amounts of the chemicals in the rubber composition. For example, the above-described techniques to control the tan δ when dry can cause the above-described tendencies also in the tan δ when wet with water.

The tire of the present disclosure includes a tread with at least one circumferential groove formed of a groove-forming rubber composition containing a rubber component and silica. The tread may be partly formed of the groove-forming rubber composition or may be entirely formed of the groove-forming rubber composition. In a desirable embodiment, the entire tread is formed of the groove-forming rubber composition.

### <Groove-Forming Rubber Composition>

The groove-forming rubber composition in the tire of the present disclosure is described below.

The groove-forming rubber composition contains a rubber component and silica.

### (Rubber Component)

The rubber component in the groove-forming rubber composition contributes to cross-linking and is usually a polymer having a weight average molecular weight (Mw) of 10000 or more.

The weight average molecular weight of the rubber component is preferably 50000 or more, more preferably 150000 or more, still more preferably 200000 or more, while it is preferably 2000000 or less, more preferably 1500000 or less, still more preferably 1000000 or less. When the weight average molecular weight is within the range indicated above, the advantageous effect tends to be better achieved.

Herein, the weight average molecular weight (Mw) can be measured by gel permeation chromatography (GPC) (GPC-8000 series available from Tosoh Corporation, detector: differential refractometer, column: TSKgel SuperMultipore HZ-M available from Tosoh Corporation) and calibrated with polystyrene standards.

The rubber component is not limited. Rubber components known in the tire field may be used. Examples include diene-based rubbers such as isoprene-based rubbers, polybutadiene rubber (BR), styrene-butadiene rubber (SBR), acrylonitrile-butadiene rubber (NBR), chloroprene rubber (CR), butyl rubber (IIR), and styrene-isoprene-butadiene copolymer rubber (SIBR). These may be used alone or in combinations of two or more. To better achieve the advantageous effect, isoprene-based rubbers, BR, and SBR are preferred.

Examples of isoprene-based rubbers include natural rubber (NR), polyisoprene rubber (IR), refined NR, modified NR, and modified IR. Examples of NR include those commonly used in the tire industry such as SIR20, RSS #3, and TSR20. Any IR may be used, including those commonly used in the tire industry such as IR2200. Examples of refined NR include deproteinized natural rubbers (DPNR) and highly purified natural rubbers (UPNR). Examples of modified NR include epoxidized natural rubbers (ENR), hydrogenated natural rubbers (HNR), and grafted natural rubbers. Examples of modified IR include epoxidized polyisoprene rubbers, hydrogenated polyisoprene rubbers, and grafted polyisoprene rubbers. These may be used alone or in combinations of two or more. NR is preferred among these.

Any BR may be used, and examples include those commonly used in the tire industry, including: high-cis BR such as BR1220 available from Zeon Corporation, BR150B available from Ube Industries, Ltd., BR1280 available from LG Chem, and BR730 available from JSR Corporation; BR containing 1,2-syndiotactic polybutadiene crystals (SPB) such as VCR412 and VCR617 both available from Ube Industries, Ltd.; and polybutadiene rubber synthesized using rare earth catalysts (rare earth-catalyzed BR). These may be used alone or in combinations of two or more.

The cis content of the BR is preferably 80% by mass or higher, more preferably 85% by mass or higher, still more preferably 90% by mass or higher, further preferably 96% by mass or higher, while it is preferably 99% by mass or lower, more preferably 98% by mass or lower, still more preferably 97% by mass or lower. When the cis content is within the range indicated above, the advantageous effect tends to be better achieved.

Here, the cis content of the BR can be measured by infrared absorption spectrometry.

When one type of BR is used, the cis content of the BR refers to the cis content of the one BR. When multiple types of BR are used, it refers to the average cis content.

The average cis content of the BR can be calculated using the equation: (Σ(amount of each BR×cis content of the each BR))/amount of total BR. For example, when 100% by mass of the rubber component includes 20% by mass of a BR having a cis content of 90% by mass and 10% by mass of a BR having a cis content of 40% by mass, the average cis content of the BR is 73.3% by mass (=(20×90+10×40)/(20+10)).

Non-limiting examples of the SBR include emulsion-polymerized styrene-butadiene rubber (E-SBR) and solution-polymerized styrene-butadiene rubber (S-SBR). Examples of usable commercial SBR include products available from Sumitomo Chemical Co., Ltd., JSR Corporation, Asahi Kasei Corporation, Zeon Corporation, etc.

The styrene content of the SBR is preferably 5% by mass or higher, more preferably 10% by mass or higher, still more preferably 15% by mass or higher, further preferably 20% by mass or higher, further preferably 23.5% by mass or higher. The styrene content is preferably 50% by mass or lower, more preferably 40% by mass or lower, still more preferably 30% by mass or lower. When the styrene content is within the range indicated above, the advantageous effect tends to be better achieved.

Herein, the styrene content of SBR is calculated by ¹H-NMR analysis.

When one type of SBR is used, the styrene content of the SBR refers to the styrene content of the one SBR. When multiple types of SBR are used, it refers to the average styrene content.

The average styrene content of the SBR can be calculated using the equation: {Σ(amount of each SBR×styrene content of the each SBR))/amount of total SBR. For example, when 100% by mass of the rubber component includes 85% by mass of a SBR having a styrene content of 40% by mass and 5% by mass of a SBR having a styrene content of 25% by mass, the average styrene content of the SBR is 39.2% by mass (=(85×40+5×25)/(85+5)).

The vinyl content of the SBR is preferably 10% by mass or higher, more preferably 20% by mass or higher, still more preferably 30% by mass or higher. The vinyl content is preferably 90% by mass or lower, more preferably 80% by mass or lower, still more preferably 70% by mass or lower. When the vinyl content is within the range indicated above, the advantageous effect tends to be better achieved.

Herein, the vinyl content (1,2-bonded butadiene unit content) of SBR can be measured by infrared absorption spectrometry.

The vinyl content of the SBR refers to the ratio (unit: % by mass) of vinyl bonds (1,2-bonded butadiene units) based on the total mass of the butadiene moieties in the SBR taken as 100. The sum of the vinyl content (% by mass), the cis content (% by mass), and the trans content (% by mass) equals 100 (% by mass). When one type of SBR is used, the vinyl content of the SBR refers to the vinyl content of the one SBR. When multiple types of SBR are used, it refers to the average vinyl content.

The average vinyl content of the SBR can be calculated using the equation: Σ(amount of each SBR×(100 (% by mass)−styrene content (% by mass) of the each SBR)×vinyl content (% by mass) of the each SBR)/Σ(amount of each SBR×(100 (% by mass)−styrene content (% by mass) of the each SBR)). For example, when 100 parts by mass of the rubber component includes 75 parts by mass of a SBR having a styrene content of 40% by mass and a vinyl content of 30% by mass, 15 parts by mass of a SBR having a styrene content of 25% by mass and a vinyl content of 20% by mass, and the remaining 10 parts by mass of a rubber component other than SBR, the average vinyl content of the SBR is 28% by mass (=(75×(100 (% by mass)−40 (% by mass))×30 (% by mass)+15×(100 (% by mass)−25 (% by mass))×20 (% by mass))/(75×(100 (% by mass)−40 (% by mass))+15×(100 (% by mass)−25 (% by mass))).

The rubber component may include oil-extended rubbers which have been extended with an oil. These may be used alone or in combinations of two or more. Examples of the oil used in oil-extended rubbers include those described below. The amount of the oil in an oil-extended rubber is not limited, and it is usually about 10 to 50 parts by mass per 100 parts by mass of the rubber solids content.

The rubber component may be modified to introduce therein a functional group interactive with filler such as silica.

Examples of the functional group include a silicon-containing group (—SiR₃ where each R is the same or different and represents a hydrogen atom, a hydroxyl group, a hydrocarbon group, an alkoxy group, or the like), an amino group, an amide group, an isocyanate group, an imino group, an imidazole group, a urea group, an ether group, a carbonyl group, an oxycarbonyl group, a mercapto group, a sulfide group, a disulfide group, a sulfonyl group, a sulfinyl group, a thiocarbonyl group, an ammonium group, an imide group, a hydrazo group, an azo group, a diazo group, a carboxy group, a nitrile group, a pyridyl group, an alkoxy group, a hydroxyl group, an oxy group, and an epoxy group, each of which may be substituted. Preferred among these is a silicon-containing group. More preferred is —SiR₃ where each R is the same or different and represents a hydrogen atom, a hydroxyl group, a hydrocarbon group (preferably a C1-C6 hydrocarbon group, more preferably a C1-C6 alkyl group), or an alkoxy group (preferably a C1-C6 alkoxy group), and at least one R is a hydroxy group.

Specific examples of the compound (modifier) used to introduce the functional group include 2-dimethylaminoethyltrimethoxysilane, 3-dimethylaminopropyltrimethoxysilane, 2-dimethylaminoethyltriethoxysilane, 3-dimethylaminopropyltriethoxysilane, 2-diethylaminoethyltrimethoxysilane, 3-diethylaminopropyltrimethoxysilane, 2-diethylaminoethyltriethoxysilane, and 3-diethylaminopropyltriethoxysilane.

A hydrophilic modified rubber is also usable as a rubber component in the groove-forming rubber composition.

Herein, the term “hydrophilic/hydrophilicity” refers to having a higher affinity for water than organic solvents. For example, the hydrophilicity of a polymer can be quantified by measuring the partition coefficient between water (or a buffered aqueous solution) and a water-immiscible organic solvent such as octanol, ethyl acetate, methylene chloride, or methyl tert-butyl ether. A polymer whose concentration is higher in water than that in an organic solvent at equilibrium is considered as hydrophilic. The modified polymer may be imparted with “hydrophilicity” by various methods which can impart hydrophilicity. For example, hydrophilicity can be imparted by introducing a below-described acidic functional group or basic functional group to rubber.

Examples of the hydrophilic modified rubber include a modified rubber which has been modified with an acid (hereinafter, also referred to as “acid-modified rubber”) and a modified rubber which has been modified with a base (hereinafter, also referred to as “base-modified rubber”).

Examples of the acidic functional group (acidic group) in the acid-modified rubber include a carboxylic acid group (carboxy group), a sulfonic acid group, a phosphoric acid group, and a phenolic hydroxy group. Hydrogen atoms in the acidic functional group may be replaced by metal atoms or the like or may be dissociated. In order to better achieve the advantageous effect, in particular, a carboxylic acid group (—COOH), a sulfonic acid group (—SO₃H), a phosphoric acid group (H₂PO₄⁻), or a salt thereof (a salt consisting of a carboxylic acid ion (—COO—), a sulfonic acid ion (—SO₃⁻), or a phosphoric acid ion (PO₄³⁻) and a counter cation of the ion) is desirable. The counter cation may be any cation capable of forming a salt, such as Na⁺ or K⁺.

The mechanism for the advantageous effect is not completely clear, but it is assumed as follows.

When a modified polymer containing a carboxylic acid group or the like is used, ionic bonds with a higher ionicity are formed between the polymer and the ionic coupling agent bound to the surface of the silica. Therefore, presumably, in driving under water-wet conditions, energy loss is likely to occur in the inner part of the rubber, and a loss coefficient tan δ is enhanced. Thus, presumably, wet performance is improved.

Examples of the basic functional group (basic group) in the base-modified rubber include an amino group, an imino group (═NH), an ammonium salt group, and a heterocyclic group containing a basic nitrogen atom.

The amino group may be any of a primary amino group (—NH₂), a secondary amino group (—NHR), and a tertiary amino group (—NRR′).

Examples of the R or R′ include substituted or unsubstituted monovalent hydrocarbon groups which may be linear, branched, or cyclic. The R or R′ may be either of a saturated hydrocarbon group or an unsaturated hydrocarbon group and may contain a heteroatom such as an oxygen atom.

The carbon number of the substituted or unsubstituted monovalent hydrocarbon groups as R or R′ is preferably 1 to 10, more preferably 1 to 8, still more preferably 1 to 6.

Examples of the substituted or unsubstituted monovalent hydrocarbon groups as R or R′ include substituted or unsubstituted aliphatic, alicyclic, or aromatic hydrocarbon groups optionally containing a heteroatom. Specific examples include a linear alkyl group, a branched alkyl group, a cyclic alkyl group, an aryl group, and an aralkyl group, all of which are substituted or unsubstituted and may optionally contain a heteroatom.

When the R or R′ is a substituted or unsubstituted linear or branched alkyl group optionally containing a heteroatom, the carbon number thereof is preferably 1 to 8, more preferably 1 to 4, still more preferably 1 or 2. When the R or R′ is a substituted or unsubstituted cyclic alkyl group optionally containing a heteroatom, the carbon number thereof is preferably 3 to 12. When the R or R′ is a substituted or unsubstituted aryl group optionally containing a heteroatom, the carbon number thereof is preferably 6 to 10. When the R or R′ is a substituted or unsubstituted aralkyl group optionally containing a heteroatom, the carbon number thereof is preferably 7 to 10.

Examples of the substituted or unsubstituted linear or branched alkyl group optionally containing a heteroatom include a methyl group, an ethyl group, a n-propyl group, an isopropyl group, a n-butyl group, an iso-butyl group, a sec-butyl group, a tert-butyl group, a pentyl group, a hexyl group, a heptyl group, a 2-ethylhexyl group, an octyl group, a nonyl group, a decyl groups, and these groups each containing a heteroatom. Examples of the substituted or unsubstituted cyclic alkyl group optionally containing a heteroatom include a cyclopropyl group, a cyclobutyl group, a cyclopentyl group, a cyclohexyl group, a cycloheptyl group, a cyclooctyl group, an adamantyl group, a 1-ethylcyclopentyl group, and a 1-ethylcyclohexyl group. Examples of the substituted or unsubstituted aryl group optionally containing a heteroatom include a phenyl group, a tolyl group, a xylyl group, a biphenyl group, a naphthyl group, an anthryl group, a phenanthryl group, and these groups each optionally containing a heteroatom. Examples of the substituted or unsubstituted aralkyl group optionally containing a heteroatom include a benzyl group, a phenethyl group, and these groups each optionally containing a heteroatom.

Examples of the ammonium salt group include a tertiary ammonium salt group and a quaternary ammonium salt group.

Examples of the heterocyclic group containing a basic nitrogen atom include nitrogen-containing heterocyclic groups such as a pyridine group, a pyrimidine group, a pyrazine group, an imidazole group, a thiol-containing imidazole group, a triazole group, and a thiazole group.

Dispersion of such a heterocyclic group in rubber is facilitated due to the double bonds in the group.

Preferred among the basic functional groups are a pyridine group, an imidazole group, a thiazole group, and an amino group (a primary amino group, a secondary amino group, or a tertiary amino group), with an amino group being more preferred.

Examples of a polymer constituting the backbone of the hydrophilic modified rubber include the above-described diene-based rubbers.

The hydrophilic modified rubber is preferably acid-modified SBR or acid-modified BR, more preferably carboxylic acid-modified SBR, sulfonic acid-modified SBR, carboxylic acid-modified BR, sulfonic acid-modified BR, or a salt thereof, still more preferably carboxylic acid-modified SBR, carboxylic acid-modified BR, or a salt thereof.

The amount of isoprene-based rubbers (NR, IR, acid-modified isoprene-based rubber, base-modified isoprene-based rubber, etc.), if present, in the groove-forming rubber composition based on 100% by mass of the rubber component is preferably 5% by mass or more, more preferably 8% by mass or more, still more preferably 10% by mass or more, while it is preferably 30% by mass or less, more preferably 25% by mass or less, still more preferably 20% by mass or less. When the amount is within the range indicated above, the advantageous effect tends to be better achieved.

The amount of BR (unmodified BR, acid-modified BR, base-modified BR, etc.), if present, in the groove-forming rubber composition based on 100% by mass of the rubber component is preferably 5% by mass or more, more preferably 10% by mass or more, still more preferably 15% by mass or more, particularly preferably 20% by mass or more, while it is preferably 50% by mass or less, more preferably 40% by mass or less, still more preferably 35% by mass or less, particularly preferably 30% by mass or less. When the amount is within the range indicated above, the advantageous effect tends to be better achieved.

The amount of SBR (unmodified SBR, acid-modified SBR, base-modified SBR, etc.), if present, in the groove-forming rubber composition based on 100% by mass of the rubber component is preferably 50% by mass or more, more preferably 60% by mass or more, still more preferably 65% by mass or more, particularly preferably 70% by mass or more, while it is preferably 95% by mass or less, more preferably 90% by mass or less, still more preferably 85% by mass or less, particularly preferably 80% by mass or less. When the amount is within the range indicated above, the advantageous effect tends to be better achieved.

The total amount of SBR (unmodified SBR, acid-modified SBR, base-modified SBR, etc.) and BR (unmodified BR, acid-modified BR, base-modified BR, etc.), if both are present, in the groove-forming rubber composition based on 100% by mass of the rubber component is preferably 50% by mass or more, more preferably 70% by mass or more, still more preferably 80% by mass or more, particularly preferably 90% by mass or more. When the total is within the range indicated above, the advantageous effect tends to be better achieved.

### (Filler)

The groove-forming rubber composition contains silica.

Examples of usable silica include dry silica (anhydrous silica) and wet silica (hydrous silica). Wet silica is preferred among these because it contains a large number of silanol groups. Usable commercial products are available from Evonik Degussa, Rhodia, Tosoh Silica Corporation, Solvay Japan, Tokuyama Corporation, etc. These may be used alone or in combinations of two or more.

The nitrogen adsorption specific surface area (N₂SA) of the silica is preferably 100 m²/g or more, more preferably 150 m²/g or more, still more preferably 170 m²/g or more, further preferably 175 m²/g or more, particularly preferably 200 m²/g or more. The upper limit of the N₂SA of the silica is not limited, and it is preferably 350 m²/g or less, more preferably 300 m²/g or less, still more preferably 250 m²/g or less. When the N₂SA is within the range indicated above, the advantageous effect tends to be better achieved.

Here, the N₂SA of the silica is measured by the BET method in accordance with ASTM D3037-93.

The amount of the silica (amount of silica without surface modification) per 100 parts by mass of the rubber component in the groove-forming rubber composition is preferably 10 parts by mass or more, more preferably 50 parts by mass or more, still more preferably 60 parts by mass or more, further preferably 70 parts by mass or more, particularly preferably 75 parts by mass or more. The upper limit of the amount is preferably 150 parts by mass or less, more preferably 120 parts by mass or less, still more preferably 100 parts by mass or less, particularly preferably 90 parts by mass or less. When the amount is within the range indicated above, the advantageous effect tends to be better achieved.

A surface-modified silica having a basic molecule on its surface is also usable as the silica in the groove-forming rubber composition.

Non-limiting examples of silica constituting the surface-modified silica include the above-described dry silica (anhydrous silica) and wet silica (hydrous silica). The N₂SA of silica constituting the surface-modified silica is desirably within the above-described range.

Any molecule with basicity is usable as a basic molecule constituting the surface-modified silica. For example, basic functional group-containing compounds are suitably usable. Examples of the basic functional group include those basic functional groups described above. Preferred among the basic functional groups are a pyridine group, an imidazole group, a thiazole group, and an amino group (a primary amino group, a secondary amino group, or a tertiary amino group), with an amino group being more preferred.

The amino group-containing compound as a basic compound is not limited. For example, a compound containing a primary, secondary, or tertiary amino group and an alkoxysilyl group in one molecule is suitably usable. Specifically, a compound represented by the following Formula (I) or (II) is suitable as the amino group-containing compound.

(R¹¹O)ₙR¹²₃₋ₙ—Si—R¹³—NR¹⁴R¹⁵ (I)

In Formula (I), R¹¹, R¹², R¹⁴ and R¹⁵ each independently represent a hydrogen atom or a substituted or unsubstituted monovalent hydrocarbon group; R¹³ represents a substituted or unsubstituted divalent hydrocarbon group; and n represents 1 to 3.

(R²¹O)ₚR²²₃₋ₚ—Si—R²³—NR²⁴—R²⁵—Si— (R²⁶O)_{q}R²⁷_{3-q} (II)

In Formula (II), R²¹, R²², R²⁴, R²⁶ and R²⁷ each independently represent a hydrogen atom or a substituted or unsubstituted monovalent hydrocarbon group; R²³ and R²⁵ each independently represent a substituted or unsubstituted divalent hydrocarbon group; and p and q each independently represent 1 to 3.

The substituted or unsubstituted monovalent or divalent hydrocarbon group as any of R¹¹ to R¹⁵ in Formula (I) or any of R²¹ to R²⁷ in Formula (II) may be linear, branched, or cyclic. The substituted or unsubstituted monovalent or divalent hydrocarbon group as any of R¹¹ to R¹⁵ in Formula (I) or any of R²¹ to R²⁷ in Formula (II) may be either of a saturated hydrocarbon group or an unsaturated hydrocarbon group and may contain a heteroatom such as an oxygen atom.

The carbon number of the substituted or unsubstituted monovalent hydrocarbon group as any of R¹¹, R¹², R¹⁴ and R¹⁵ in Formula (I) or any of R²¹, R²², R²⁴, R²⁶ and R²⁷ in Formula (II) is preferably 1 to 10, more preferably 1 to 8, still more preferably 1 to 6. The carbon number of the substituted or unsubstituted divalent hydrocarbon group as R¹³ in Formula (I) or R²³ or R²⁵ in Formula (II) is preferably 1 to 10, more preferably 1 to 8, still more preferably 1 to 6.

Specific examples of R¹¹, R¹², R¹⁴ or R¹⁵ in Formula (I) or R²¹, R²², R²⁴, R²⁶ or R²⁷ in Formula (II) include the above-described substituted or unsubstituted monovalent hydrocarbon groups as R or R′.

Specific examples of the substituted or unsubstituted divalent hydrocarbon group as R¹³ in Formula (I) or R²³ or R²⁵ in Formula (II) include a substituted or unsubstituted C1-C18 alkylene group optionally containing a heteroatom and a substituted or unsubstituted C5-C18 cycloalkylene group optionally containing a heteroatom. Specific examples include a methylene group, an ethylene group, a trimethylene group, a tetramethylene group, a pentamethylene group, a hexamethylene group, an octylene group, a nonylene group, a decylene group, and a 1,2-propylene group.

Specific examples of the amino group-containing compound represented by Formula (I) include 3-aminopropyltrimethoxysilane, 3-aminopropyltriethoxysilane, N-[3-(trimethoxysilyl)propyl]-1-butanamine, N-2-(aminoethyl)-3-aminopropyltrimethoxysilane, N-2-(aminobutyl)-3-aminobutyltrimethoxysilane, and N-2-(aminoethyl)-3-aminopropylmethyltrimethoxysilane.

Specific examples of the amino group-containing compound represented by Formula (II) include bis(3-trimethoxysilylpropyl)amine, bis(3-triethoxysilylpropyl)amine, bis(4-trimethoxysilylbutyl)amine, bis(triethoxysilylmethyl)amine, and bis(6-trimethoxysilylhexyl)amine.

Specific examples of the amino group-containing compound other than those described above include amino group-containing aromatic compounds such as N-phenyl-3-aminopropyltrimethoxysilane; amino group-containing dialkoxysilane compounds such as 3-aminopropylmethyldimethoxysilane, 3-aminopropylmethyldiethoxysilane, N-2-(aminoethyl)-3-aminopropylmethyldimethoxysilane, and bis(3-methyldimethoxysilylpropyl)amine; and ethylenediamine compounds such as N,N′-bis[3-(trimethoxysilyl)propyl]ethylenediamine and N-(2-aminoethyl)-N′-(3-(trimethoxysilyl)propyl)ethylenediamine.

The method of producing the surface-modified silica having a basic molecule on its surface (method of treating (coating) the surface of the silica with the basic molecule) may be performed by a method that can bring the basic molecule into contact with the silica. For example, the surface-modified silica having a basic molecule on its surface can be prepared by mixing a basic compound and silica by a known method. Specifically, the basic molecule, the silica, and other components such as polymers are kneaded with a kneading apparatus such as an open roll mill or a Banbury mixer so that the surface-modified silica having a basic molecule on its surface is generated in the kneaded mixture. Alternatively, it can be produced by mixing only the basic compound and the silica by a known method.

The amount of the surface-modified silica per 100 parts by mass of the rubber component in the groove-forming rubber composition is preferably 10 parts by mass or more, more preferably 50 parts by mass or more, still more preferably 70 parts by mass or more, further preferably 75 parts by mass or more, further preferably 79 parts by mass or more. The upper limit of the amount is preferably 150 parts by mass or less, more preferably 120 parts by mass or less, still more preferably 100 parts by mass or less, particularly preferably 90 parts by mass or less. When the amount is within the range indicated above, the advantageous effect tends to be better achieved.

Here, the amount of the surface-modified silica refers to a total amount of the silica and the basic molecule per 100 parts by mass of the rubber component in the groove-forming rubber composition. The amount includes the amount of basic molecules which are not attached to the surface of the silica. In the case where the basic molecule is an amino group-containing compound, the range is also suitable for the amount of silica having the amino group-containing compound on its surface.

The amount of the basic molecule in the groove-forming rubber composition per 100 parts by mass of all the silica in the groove-forming rubber composition is preferably 2.0 parts by mass or more, more preferably 4.0 parts by mass or more, still more preferably 6.0 parts by mass or more. The amount is preferably 30.0 parts by mass or less, more preferably 20.0 parts by mass or less, still more preferably 15.0 parts by mass or less. When the amount is within the range indicated above, the advantageous effect can be suitably achieved.

The total amount of silica (total amount of silica without surface modification and silica with surface modification such as the surface-modified silica) per 100 parts by mass of the rubber component in the groove-forming rubber composition is preferably 10 parts by mass or more, more preferably 50 parts by mass or more, still more preferably 70 parts by mass or more, particularly preferably 75 parts by mass or more. The upper limit of the amount is preferably 150 parts by mass or less, more preferably 120 parts by mass or less, still more preferably 100 parts by mass or less, particularly preferably 90 parts by mass or less. When the total amount is within the range indicated above, the advantageous effect tends to be better achieved.

The groove-forming rubber composition may contain different fillers other than silica.

The amount of fillers (total amount of fillers including silica and different fillers) per 100 parts by mass of the rubber component in the groove-forming rubber composition is preferably 10 parts by mass or more, more preferably 50 parts by mass or more, still more preferably 70 parts by mass or more, further preferably 75 parts by mass or more, further preferably 85 parts by mass or more. The upper limit of the amount is preferably 150 parts by mass or less, more preferably 120 parts by mass or less, still more preferably 100 parts by mass or less, particularly preferably 90 parts by mass or less. When the amount is within the range indicated above, the advantageous effect tends to be better achieved.

The silica content (total content of silica without surface modification and silica with surface modification such as the surface-modified silica) based on 100% by mass of fillers in the groove-forming rubber composition is preferably 60% by mass or higher, more preferably 80% by mass or higher, still more preferably 85% by mass or higher, further preferably 90% by mass or higher, particularly preferably 95% by mass or higher, and may be 100% by mass. When the content is within the range indicated above, the advantageous effect tends to be better achieved.

The different fillers are not limited, and materials known in the rubber field are usable. Examples include inorganic fillers such as carbon black, calcium carbonate, talc, alumina, clay, aluminum hydroxide, aluminum oxide, and mica. To better achieve the advantageous effect, carbon black is preferred.

Non-limiting examples of carbon black usable in the groove-forming rubber composition include N134, N110, N220, N234, N219, N339, N330, N326, N351, N550, and N762. Usable commercial products are available from Asahi Carbon Co., Ltd., Cabot Japan K.K., Tokai Carbon Co., Ltd., Mitsubishi Chemical Corporation, Lion Corporation, NSCC Carbon Co., Ltd., Columbia Carbon, etc. These may be used alone or in combinations of two or more.

The nitrogen adsorption specific surface area (N₂SA) of the carbon black is preferably 30 m²/g or more, more preferably 50 m²/g or more, still more preferably 70 m²/g or more, further preferably 114 m²/g or more. The N₂SA is preferably 200 m²/g or less, more preferably 150 m²/g or less, still more preferably 130 m²/g or less, particularly preferably 120 m²/g or less. When the N₂SA is within the range indicated above, the advantageous effect tends to be better achieved.

Here, the N₂SA of the carbon black can be determined in accordance with JIS K 6217-2:2001.

The amount of carbon black, if present, in the groove-forming rubber composition per 100 parts by mass of the rubber component is preferably 1 part by mass or more, more preferably 3 parts by mass or more, still more preferably 5 parts by mass or more. The upper limit of the amount is preferably 30 parts by mass or less, more preferably 20 parts by mass or less, still more preferably 10 parts by mass or less. When the amount is within the range indicated above, the advantageous effect tends to be better achieved.

A metal oxide is also usable as a different filler in the groove-forming rubber composition.

Examples of the metal oxide include single metal oxides and composite metal oxides, such as compounds represented by MxOy (wherein M represents a metal atom, and x and y each independently represent an integer of 1 to 6). These may be used alone or in combinations of two or more. The metal oxide is preferably not zinc oxide.

Specific examples of the metal oxide include alkali metal oxides such as lithium oxide, sodium oxide, potassium oxide, rubidium oxide, and cesium oxide; alkaline earth metal oxides such as calcium oxide, strontium oxide, and barium oxide; transition metal oxides such as scandium oxide, titanium oxide, vanadium oxide, chromium oxide, manganese oxide, iron oxide, cobalt oxide, nickel oxide, copper oxide, yttrium oxide, zirconium oxide, niobium oxide, molybdenum oxide, technetium oxide, ruthenium oxide, rhodium oxide, palladium oxide, silver oxide, hafnium oxide, tantalum oxide, tungsten oxide, osmium oxide, iridium oxide, platinum oxide, and gold oxide; and base metal oxides such as beryllium oxide, magnesium oxide, aluminum oxide, gallium oxide, cadmium oxide, indium oxide, tin oxide, thallium oxide, lead oxide, bismuth oxide, and polonium oxide. The metal oxide may be used alone or as a mixture of two or more thereof.

In order to suitably achieve the advantageous effect, the groove-forming rubber composition preferably contains at least one selected from the group consisting of lithium oxide, sodium oxide, potassium oxide, rubidium oxide, cesium oxide, beryllium oxide, magnesium oxide, calcium oxide, strontium oxide, and barium oxide, more preferably contains at least one selected from the group consisting of beryllium oxide, magnesium oxide, calcium oxide, strontium oxide, and barium oxide, still more preferably contains magnesium oxide.

The amount of the metal oxide (total amount of the metal oxides) per 100 parts by mass of the polymer component in the groove-forming rubber composition is preferably 0.5 parts by mass or more, more preferably 1.0 parts by mass or more, still more preferably 2.0 parts by mass or more, particularly preferably 2.2 parts by mass or more, while it is preferably 10.0 parts by mass or less, more preferably 5.0 parts by mass or less, still more preferably 4.4 parts by mass or less, further preferably 4.0 parts by mass or less, particularly preferably 3.0 parts by mass or less. When the amount is within the range indicated above, the advantageous effect tends to be better achieved. Here, the range is also suitable for the total amount of at least one selected from the group consisting of lithium oxide, sodium oxide, potassium oxide, rubidium oxide, cesium oxide, beryllium oxide, magnesium oxide, calcium oxide, strontium oxide, and barium oxide, the total amount of at least one selected from the group consisting of beryllium oxide, magnesium oxide, calcium oxide, strontium oxide, and barium oxide, and the amount of magnesium oxide.

The apparent specific gravity of the metal oxide is preferably less than 0.4 g/ml, more preferably 0.36 g/ml or less, still more preferably 0.3 g/ml or less, further preferably 0.25 g/ml or less, while it is preferably 0.05 g/ml or more, more preferably 0.15 g/ml or more. When the apparent specific gravity is within the range indicated above, the advantageous effect tends to be better achieved. The range is also suitable for the apparent specific gravity of magnesium oxide.

Here, the apparent specific gravity of the metal oxide is determined by weighing 30 ml by apparent volume of the metal oxide into a 50-ml measuring cylinder and calculating the apparent specific gravity from the mass.

The d50 of the metal oxide is preferably less than 10 μm, more preferably 4.5 μm or less, still more preferably 4.46 μm or less, further preferably 1.5 μm or less, particularly preferably less than 0.75 μm, while it is preferably 0.05 μm or more, more preferably 0.45 μm or more. When the d50 is within the range indicated above, the advantageous effect tends to be better achieved. The range is also suitable for the d50 of magnesium oxide.

Here, the d50 of the metal oxide refers to a particle size corresponding to the 50th percentile of a mass-based particle size distribution curve obtained by a laser diffraction method.

The nitrogen adsorption specific surface area (N₂SA) of the metal oxide is preferably 100 m²/g or more, more preferably 115 m²/g or more, still more preferably 145 m²/g or more, while it is preferably 250 m²/g or less, more preferably 225 m²/g or less, still more preferably 200 m²/g or less. When the N₂SA is within the range indicated above, the advantageous effect tends to be better achieved. The range is also suitable for the N₂SA of magnesium oxide.

Here, the N₂SA of the metal oxide is measured by the BET method in accordance with JIS Z 8830:2013.

Usable commercial products of the metal oxide are available from Kyowa Chemical Industry, FUJIFILM Wako Pure Chemical Corporation, KISHIDA CHEMICAL Co., Ltd., Kyowa Chemical Industry, Tateho Chemical Industries Co., Ltd., JHE Co., Ltd, Nippon Chemical Industrial Co., Ltd, Ako Kasei Co., Ltd., etc.

The amount of the metal oxide, if present, in the groove-forming rubber composition per 100 parts by mass of the rubber component is preferably 1 part by mass or more, more preferably 2.2 parts by mass or more, still more preferably 3 parts by mass or more, further preferably 5 parts by mass or more. The upper limit of the amount is preferably 30 parts by mass or less, more preferably 20 parts by mass or less, still more preferably 10 parts by mass or less. When the amount is within the range indicated above, the advantageous effect tends to be better achieved.

### (Coupling Agent)

The groove-forming rubber composition preferably contains a coupling agent.

Herein, the term “coupling agent” refers to a compound which binds (via covalent bond, ionic bond, or the like) to or interacts with both silica and polymers (e.g., rubber components, liquid polymers). The addition of the coupling agent causes bonding or interaction between the coupling agent and the silica and between the coupling agent and the polymer.

The total amount of the coupling agent (total amount of coupling agents such as ionic coupling agents and silane coupling agents which are described later) per 100 parts by mass of the silica is preferably 1.0 parts by mass or more, more preferably 2.5 parts by mass or more, still more preferably 4.0 parts by mass or more, further preferably 4.53 parts by mass or more, further preferably 5.0 parts by mass or more, further preferably 5.44 parts by mass or more, further preferably 6.72 parts by mass or more, further preferably 6.8 parts by mass or more. The upper limit of the amount is preferably 50.0 parts by mass, more preferably 20.0 parts by mass or less, still more preferably 15.0 parts by mass or less, particularly preferably 10.0 parts by mass or less. When the total amount is within the range indicated above, the advantageous effect tends to be better achieved.

The coupling agent may be any compound capable of binding to or interacting with both the silica and the polymer. In order to better achieve the advantageous effect, an ionic coupling agent is desirable.

The mechanism for the advantageous effect is not completely clear, but it is assumed as follows.

When an ionic coupling agent is added, ionic bonds are formed between the polymer and the ionic coupling agent bound to the surface of the silica. Due to the reversibility of the ionic bonds, the cross-link between the silica and the polymer is cleaved only when wet with water, thereby increasing the mobility of the polymer from which the ionic bonds are dissociated. Therefore, presumably, in driving under water-wet conditions, energy loss is likely to occur in the inner part of the rubber, and a loss coefficient tan δ is enhanced. Thus, presumably, the wet performance is improved.

Herein, the term “ionic coupling agent” refers to a compound that causes ionic bonding or ionic interaction with silica and polymers (e.g., rubber components, liquid polymers). The addition of the ionic coupling agent causes ionic bonding or ionic interaction between the ionic coupling agent and the silica and between the ionic coupling agent and the polymer.

The ionic coupling agent may be any compound capable of ionic binding to or ionic interacting with both silica and polymers (e.g., rubber components, liquid polymers). In order to better achieve the advantageous effect, the groove-forming rubber composition preferably contains at least one selected from the group consisting of compounds represented by the following Formula (1), hydrolysates of compounds represented by Formula (1), and hydrolysis condensates of compounds represented by Formula (1).

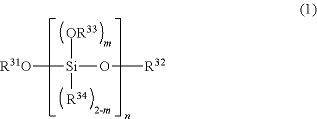

In Formula (1), R³¹ and R³² each independently represent a monovalent organic group; R³³ and R³⁴ each independently represent an organic group containing a group selected from the group consisting of an alkyl group, a vinyl group, an epoxy group, a styryl group, a (meth)acryl group, an amino group, an isocyanurate group, an ureido group, a mercapto group, a sulfide group, a polyalkyleneoxyalkyl group, a carboxy group, and a quaternary ammonium group; at least one R³⁴ represents an organic group containing a quaternary ammonium group; m each independently represents an integer of 0 to 2; and n represents an integer.

In the present disclosure, the term “organic group” refers to a group with a carbon number of 1 or more.

The term “hydrolysates of compounds represented by Formula (1)” refers to compounds obtained by hydrolyzing at least part of substituents on silicon atoms of the compounds represented by Formula (1) into silanol groups.

The term “hydrolysis condensates of compounds represented by Formula (1)” refers to compounds formed by condensation of at least two compounds selected from the group consisting of compounds represented by Formula (1) and hydrolysates of compounds represented by Formula (1).

In Formula (1), m is preferably 1 or 2, more preferably 2.

In Formula (1), n is preferably an integer of 2 to 20.

In Formula (1), the monovalent organic group as R³¹ or R³² preferably has a carbon number of 1 to 6.

The C1-C6 organic group as R³¹ or R³²² may be linear, branched, or cyclic. Examples of the C1-C6 organic group include an alkyl group and an alkenyl group, and an alkyl group is preferred. Examples of the C1-C6 alkyl group include a methyl group, an ethyl group, a propyl group, an isopropyl group, a n-butyl group, a tert-butyl group, a n-pentyl group, a n-hexyl group, and a cyclohexyl group.

In Formula (1), R³¹ and R³² each independently represent preferably a C1-C6 alkyl group, more preferably a C1-C4 alkyl group, still more preferably a methyl group or an ethyl group, particularly preferably a methyl group.

In Formula (1), R³³ each independently represents preferably a C1-C6 alkyl group, more preferably a C1-C4 alkyl group, still more preferably a methyl group or an ethyl group, particularly preferably a methyl group.

In Formula (1), at least one R³⁴ represents an organic group containing a quaternary ammonium group.

Examples of the group containing a quaternary ammonium group include groups represented by the following formula.

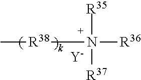

In the formula, R³⁵ to R³⁷ each independently represent a monovalent organic group; R³¹ each independently represents a divalent organic group; Y-represents an anion; and k represents an integer.

Examples of the monovalent organic group as any of R³⁵ to R³⁷ include monovalent hydrocarbon groups. Examples of the monovalent hydrocarbon groups include C1-C12 alkyl groups and C2-C12 alkenyl groups.

The carbon number of any of R³⁵ to R³ is preferably 1 to 12, more preferably 1 to 7, still more preferably 1 to 5, particularly preferably 1 to 3.

The monovalent organic group as any of R³⁵ to R³⁷ is particularly preferably a methyl group or an ethyl group.

Examples of the divalent organic group as R³⁸ include divalent hydrocarbon groups. Examples of the divalent hydrocarbon groups include C1-C12 alkylene groups and C2-C12 alkenylene groups.

The carbon number of R³⁸ is preferably 1 to 12, more preferably 1 to 7, still more preferably 1 to 5, particularly preferably 1 to 3.

The divalent organic group as R³⁸ is particularly preferably a methylene group or an ethylene group.

Preferably, k is 0 to 5, more preferably 0 to 3, still more preferably 0 to 1, particularly preferably 0.

Non-limiting examples of Y— include halide ions such as chlorine ion, bromine ion, and iodine ion; alkyl sulfate ions such as methyl sulfate ion; and organic acid ions such as acetic acid ion.

In order to better achieve the advantageous effect, desirable among compounds represented by Formula (1), hydrolysates of compounds represented by Formula (1), and hydrolysis condensates of compounds represented by Formula (1) are compounds represented by the following Formula (1-1).

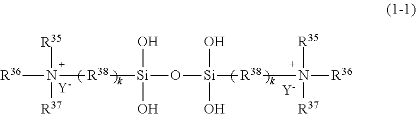

In Formula (1-1), R³⁵ to R³⁷ each independently represent the group described above for R³⁵ to R³⁷; R³⁸ each independently represents the group described above for R³⁸; Y⁻ each independently represents the anion described above for Y⁻; and k each independently represents the integer described above for k.

In Formula (1-1), preferred examples of R³⁵ to R³⁷, R³⁸, Y⁻, and k include those described above.

The advantageous effect can be better achieved when the ionic coupling agent is a compound having a salt structure such as a quaternary ammonium salt, for example, a compound represented by Formula (1-1). The mechanism for the advantageous effect is not completely clear, but it is assumed as follows.

In the case of an ionic coupling agent having a salt structure such as the one represented by —N⁺ (R³⁵) (R³⁶) (R³⁷)Y⁻, ionic bonds with a higher ionicity are formed between the polymer and the ionic coupling agent bound to the surface of the silica. Therefore, presumably, in driving under water-wet conditions, energy loss is likely to occur in the inner part of the rubber, and a loss coefficient tan δ is enhanced. Thus, presumably, wet performance is improved.

Examples of usable commercial products of the ionic coupling agent include X-12-1126 available from Shin-Etsu Chemical Co., Ltd.

The amount of the ionic silane coupling agent (preferably, the total amount of compounds represented by Formula (1), hydrolysates of compounds represented by Formula (1), and hydrolysis condensates of compounds represented by Formula (1)) per 100 parts by mass of the silica is preferably 1.0 parts by mass or more, more preferably 2.5 parts by mass or more, still more preferably 2.72 parts by mass or more, further preferably 4.0 parts by mass or more, further preferably 4.53 parts by mass or more, further preferably 5.0 parts by mass or more, further preferably 5.44 parts by mass or more, further preferably 6.8 parts by mass or more. The upper limit of the amount is preferably 50.0 parts by mass, more preferably 20.0 parts by mass or less, still more preferably 15.0 parts by mass or less, particularly preferably 10.0 parts by mass or less. When the amount is within the range indicated above, the advantageous effect tends to be better achieved.

The groove-forming rubber composition may contain a known silane coupling agent as a coupling agent other than the ionic coupling agent.

The silane coupling agent may be any silane coupling agent including those known in the rubber field. Examples include sulfide silane coupling agents such as bis(3-triethoxysilylpropyl) tetrasulfide, bis(2-triethoxysilylethyl) tetrasulfide, bis(4-triethoxysilylbutyl) tetrasulfide, bis(3-trimethoxysilylpropyl) tetrasulfide, bis(2-trimethoxysilylethyl) tetrasulfide, bis(2-triethoxysilylethyl) trisulfide, bis(4-trimethoxysilylbutyl) trisulfide, bis(3-triethoxysilylpropyl)disulfide, bis(2-triethoxysilylethyl)disulfide, bis(4-triethoxysilylbutyl)disulfide, bis(3-trimethoxysilylpropyl)disulfide, bis(2-trimethoxysilylethyl)disulfide, bis(4-trimethoxysilylbutyl)disulfide, 3-trimethoxysilylpropyl-N,N-dimethylthiocarbamoyltetrasulfide, 2-triethoxysilylethyl-N,N-dimethylthiocarbamoyltetrasulfide, and 3-triethoxysilylpropyl methacrylate monosulfide; mercapto silane coupling agents such as 3-mercaptopropyltrimethoxysilane, 2-mercaptoethyltriethoxysilane, and NXT and NXT-Z both available from Momentive; vinyl silane coupling agents such as vinyltriethoxysilane and vinyltrimethoxysilane; amino silane coupling agents such as 3-aminopropyltriethoxysilane and 3-aminopropyltrimethoxysilane; glycidoxy silane coupling agents such as γ-glycidoxypropyltriethoxysilane and γ-glycidoxypropyltrimethoxysilane; nitro silane coupling agents such as 3-nitropropyltrimethoxysilane and 3-nitropropyltriethoxysilane; and chloro silane coupling agents such as 3-chloropropyltrimethoxysilane and 3-chloropropyltriethoxysilane. Usable commercial products are available from Evonik Degussa, Momentive, Shin-Etsu Silicone, Tokyo Chemical Industry Co., Ltd., AZmax. Co., Dow Corning Toray Co., Ltd., etc. These may be used alone or in combinations of two or more.

The amount of the silane coupling agents per 100 parts by mass of the silica in the groove-forming rubber composition is preferably 0.1 parts by mass or more, more preferably 3 parts by mass or more, still more preferably 4 parts by mass or more, further preferably 5 parts by mass or more, particularly preferably 7 parts by mass or more. The upper limit of the amount is preferably 50 parts by mass or less, more preferably 20 parts by mass or less, still more preferably 15 parts by mass or less, particularly preferably 10 parts by mass or less. When the amount is within the range indicated above, the advantageous effect tends to be better achieved.

### (Plasticizer)

In order to better achieve the advantageous effect, the groove-forming rubber composition preferably contains a plasticizer. The term “plasticizer” refers to a material that can impart plasticity to rubber components. Examples include liquid plasticizers (plasticizers which are liquid at room temperature (25° C.)) and resins (resins which are solid at room temperature (25° C.)).

The amount of the plasticizer (total amount of plasticizers) per 100 parts by mass of the rubber component in the groove-forming rubber composition is preferably 5 parts by mass or more, more preferably 8 parts by mass or more, still more preferably 10 parts by mass or more. The upper limit is preferably 50 parts by mass or less, more preferably 40 parts by mass or less, still more preferably 30 parts by mass or less, further preferably 20 parts by mass or less. When the amount is within the range indicated above, the advantageous effect tends to be better achieved.

Liquid plasticizers (plasticizers which are liquid at room temperature (25° C.)) usable in the groove-forming rubber composition are not limited, and examples include oils and liquid polymers such as liquid resins, liquid diene-based polymers, and liquid farnesene-based polymers. These may be used alone or in combinations of two or more.

The amount of liquid plasticizers per 100 parts by mass of the rubber component in the groove-forming rubber composition is preferably 5 parts by mass or more, more preferably 8 parts by mass or more, still more preferably 10 parts by mass or more. The upper limit is preferably 50 parts by mass or less, more preferably 40 parts by mass or less, still more preferably 30 parts by mass or less. When the amount is within the range indicated above, the advantageous effect tends to be better achieved.

The amount of liquid plasticizers includes the amount of oils in oil-extended rubbers and oils in sulfur.

Examples of the oils include process oils, plant oils, and mixtures thereof. Examples of the process oils include paraffinic process oils, aromatic process oils, and naphthenic process oils. Examples of the plant oils include castor oil, cotton seed oil, linseed oil, rapeseed oil, soybean oil, palm oil, coconut oil, peanut oil, rosin, pine oil, pine tar, tall oil, corn oil, rice oil, safflower oil, sesame oil, olive oil, sunflower oil, palm kernel oil, camellia oil, jojoba oil, macadamia nut oil, and tung oil. Usable commercial products may be available from Idemitsu Kosan Co., Ltd., Sankyo Yuka Kogyo K.K., ENEOS Corporation, Olisoy, H&R, Hokoku Corporation, Showa Shell Sekiyu K.K., Fuji Kosan Co., Ltd., The Nisshin Oillio Group, etc. Process oils such as paraffinic process oils, aromatic process oils, and naphthenic process oils, and plant oils are preferred among these.

Examples of the liquid resins include terpene resins (including terpene phenolic resins and aromatic modified terpene resins), rosin resins, styrene resins, C5 resins, C9 resins, C5/C9 resins, dicyclopentadiene (DCPD) resins, coumarone-indene resins (including resins based on coumarone or indene alone), phenolic resins, olefin resins, polyurethane resins, and acrylic resins. Hydrogenated products of these resins are also usable.

Examples of the liquid diene-based polymers include liquid styrene-butadiene copolymers, liquid polybutadiene polymers, liquid polyisoprene polymers, liquid styrene-isoprene copolymers, liquid styrene-butadiene-styrene block copolymers (liquid SBS block polymers), liquid styrene-isoprene-styrene block copolymers (liquid SIS block polymers), liquid farnesene polymers, and liquid farnese-butadiene copolymers, all of which are liquid at 25° C. The chain ends or backbones of these polymers may be modified with a polar group. Hydrogenated products of these polymers are also usable.

In order to better achieve the advantageous effect, preferred among the liquid plasticizers which are liquid at room temperature (25° C.) are unmodified liquid polymers and modified liquid polymers, more preferred are modified liquid polymers, and still more preferred are acid-modified liquid polymers. The unmodified liquid polymers and the modified liquid polymers may each be used alone or in combinations of two or more.

Examples of the acid-modified liquid polymer include polymers which have been modified with acid compounds or derivatives thereof and which are liquid at room temperature (25° C.).

Specific examples of suitably usable acid-modified liquid polymers include acid-modified liquid polymers obtained by modifying unmodified liquid polymers with unsaturated carboxylic acids and/or derivatives thereof and acid-modified liquid polymers obtained by modifying modified liquid polymers with unsaturated carboxylic acids and/or derivatives thereof. In particular, acid-modified liquid polymers obtained by modifying unmodified liquid polymers with unsaturated carboxylic acids and/or derivatives thereof are desirably used.

The unmodified liquid polymers are unmodified liquid polymers (liquid diene-based polymers) obtained by polymerizing a conjugated diene-containing monomer, such as 1,3-butadiene, isoprene, 1,3-pentadiene, 2,3-dimethyl-1,3-butadiene, 2-methyl-1,3-pentadiene, 1,3-hexadiene, 2-methyl-1,3-pentadiene, 4,5-diethyl-1,3-octadiene, or 3-butyl-1,3-octadiene. Examples of the unmodified liquid polymers include liquid diene-based polymers, such as liquid polybutadiene, liquid polyisoprene, liquid styrene-butadiene random copolymers, liquid styrene-butadiene block copolymers, liquid butadiene-isoprene random copolymers, liquid butadiene-isoprene block copolymers, liquid styrene-butadiene-isoprene random copolymers, and liquid styrene-butadiene-isoprene block copolymers. In order to better achieve the advantageous effect, liquid polybutadiene, liquid polyisoprene, liquid styrene-butadiene random copolymers, and liquid styrene-butadiene block copolymers are preferred among these, with liquid polybutadiene and liquid polyisoprene being more preferred. These may be used alone or in admixtures of two or more.

Examples of the unsaturated carboxylic acids include maleic acid, fumaric acid, itaconic acid, and (meth)acrylic acid. Examples of derivatives of the unsaturated carboxylic acids include unsaturated carboxylic anhydrides such as maleic anhydride and itaconic anhydride; unsaturated carboxylic acid esters such as maleate, fumarate, itaconate, glycidyl(meth)acrylate, and hydroxyethyl(meth)acrylate; unsaturated carboxylic acid amides such as maleic acid amide, fumaric acid amide, and itaconic acid amide; unsaturated carboxylic acid imides such as maleic acid imide and itaconic acid imide. The modification may be performed with one or two or more unsaturated carboxylic acids or one or two or more unsaturated carboxylic acid derivatives.

The acid-modified liquid polymer may be produced by modifying an unmodified liquid polymer as a raw material with an acid compound such as an unsaturated carboxylic acid and/or a derivative thereof. Non-limiting examples of the modification method include known methods, including a method of adding an acid compound such as an unsaturated carboxylic acid and/or a derivative thereof to an unmodified liquid polymer as a raw material. The acid-modified liquid polymer may be used alone or in combinations of two or more.

In order to better achieve the advantageous effect, maleic acid-modified liquid polymers and maleic anhydride-modified liquid polymers are preferred, maleic acid-modified liquid diene-based polymers and maleic anhydride-modified liquid diene-based polymers are more preferred, maleic acid-modified liquid polybutadiene, maleic anhydride-modified liquid polybutadiene, maleic acid-modified liquid polyisoprene, and maleic anhydride-modified liquid polyisoprene are still more preferred among the acid-modified liquid polymers.

The number average molecular weight (Mn) of the acid-modified liquid polymer is preferably 2000 or more, more preferably 20000 or more, still more preferably 25000 or more, further preferably 30000 or more, further preferably 34000 or more. The Mn is preferably 100000 or less, more preferably 80000 or less, still more preferably 60000 or less, further preferably 54000 or less. The weight average molecular weight (Mw) of the acid-modified liquid polymer is desirably within the range indicated above. When the Mn and Mw are within the range indicated above, the advantageous effect tends to be better achieved.

The acid-modified liquid polymer may be a product of, for example, Kuraray, Clay Valley, etc.

The amount of the acid-modified liquid polymer per 100 parts by mass of the rubber component in the groove-forming rubber composition is preferably 5 parts by mass or more, more preferably 8 parts by mass or more, still more preferably 10 parts by mass or more. The upper limit is preferably 50 parts by mass or less, more preferably 40 parts by mass or less, still more preferably 30 parts by mass or less, further preferably 20 parts by mass or less. When the amount is within the range indicated above, the advantageous effect tends to be better achieved.

Examples of the resin (resin which is solid at room temperature (25° C.)) usable in the groove-forming rubber composition include aromatic vinyl polymers, coumarone-indene resin, coumarone resin, indene resin, phenol resin, rosin resin, petroleum resins, terpene-based resins, and acrylic resins, all of which are solid at room temperature (25° C.). The resin may be hydrogenated. These may be used alone or in combinations of two or more. Aromatic vinyl polymers, petroleum resins, and terpene-based resins are preferred among these.

The amount of the resin, if present, in the groove-forming rubber composition per 100 parts by mass of the rubber component is preferably 5 parts by mass or more, more preferably 8 parts by mass or more, still more preferably 10 parts by mass or more. The upper limit is preferably 50 parts by mass or less, more preferably 40 parts by mass or less, still more preferably 30 parts by mass or less. When the amount is within the range indicated above, the advantageous effect tends to be better achieved.

The softening point of the resin is preferably 50° C. or higher, more preferably 55° C. or higher, still more preferably 60° C. or higher, further preferably 85° C. or higher. The upper limit is preferably 160° C. or lower, more preferably 150° C. or lower, still more preferably 145° C. or lower. When the softening point is within the range indicated above, the advantageous effect tends to be better achieved. Here, the softening point of the resin is measured in accordance with JIS K 6220-1:2001 using a ring and ball softening point measuring apparatus, and the temperature at which the ball drops down is defined as the softening temperature.

The aromatic vinyl polymers refer to polymers containing aromatic vinyl monomers as structural units. Examples include resins produced by polymerizing α-methylstyrene and/or styrene. Specific examples include styrene homopolymers (styrene resins), α-methylstyrene homopolymers (α-methylstyrene resins), copolymers of α-methylstyrene and styrene, and copolymers of styrene and other monomers.

The coumarone-indene resins refer to resins containing coumarone and indene as the main monomer components forming the skeleton (backbone) of the resins. Examples of monomer components which may be contained in the skeleton in addition to coumarone and indene include styrene, α-methylstyrene, methylindene, and vinyltoluene.

The coumarone resins refer to resins containing coumarone as the main monomer component forming the skeleton (backbone) of the resins.

The indene resins refer to resins containing indene as the main monomer component forming the skeleton (backbone) of the resins.

Examples of the phenol resins include known polymers produced by reacting phenol with an aldehyde such as formaldehyde, acetaldehyde, or furfural in the presence of an acid or alkali catalyst. Preferred among these are those produced by the reaction in the presence of an acid catalyst, such as novolac phenol resins.

Examples of the rosin resins include rosin resins typified by natural rosins, polymerized rosins, modified rosins, and esterified compounds thereof, and hydrogenated products thereof.

Examples of the petroleum resins include C5 resins, C9 resins, C5/C9 resins, dicyclopentadiene (DCPD) resins, and hydrogenated products of these resins. DCPD resins and hydrogenated DCPD resins are preferred among these.

The terpene resins refer to polymers containing terpene as a structural unit. Examples include polyterpene resins produced by polymerizing terpene compounds, and aromatic modified terpene resins produced by polymerizing terpene compounds and aromatic compounds. Examples of usable aromatic modified terpene resins include terpene-phenol resins made from terpene compounds and phenolic compounds, terpene-styrene resins made from terpene compounds and styrene compounds, and terpene-phenol-styrene resins made from terpene compounds, phenolic compounds, and styrene compounds. Examples of terpene compounds include α-pinene and β-pinene. Examples of phenolic compounds include phenol and bisphenol A. Examples of aromatic compounds include styrene compounds such as styrene and α-methylstyrene.

The acrylic resins refer to polymers containing acrylic monomers as structural units. Examples include styrene acrylic-based resins, such as styrene acrylic resins, which contain carboxy groups and are produced by copolymerizing aromatic vinyl monomer components and acrylic monomer components. Solvent-free, carboxy group-containing styrene acrylic-based resins are suitably usable among these.

Examples of usable commercial plasticizers include products available from Maruzen Petrochemical Co., Ltd., Sumitomo Bakelite Co., Ltd., Yasuhara Chemical Co., Ltd., TOSOH Corporation, Rutgers Chemicals, BASF, Arizona Chemical, Nitto Chemical Co., Ltd., Nippon Shokubai Co., Ltd., ENEOS Corporation, Arakawa Chemical Industries, Ltd., Taoka Chemical Co., Ltd., etc.

### (Other Components)

The groove-forming rubber composition may contain an antioxidant.

Examples of antioxidants include naphthylamine antioxidants such as phenyl-α-naphthylamine; diphenylamine antioxidants such as octylated diphenylamine and 4,4′-bis(α,α′-dimethylbenzyl)diphenylamine; p-phenylenediamine antioxidants such as N-isopropyl-N′-phenyl-p-phenylenediamine, N-(1,3-dimethylbutyl)-N′-phenyl-p-phenylenediamine, and N,N′-di-2-naphthyl-p-phenylenediamine; quinoline antioxidants such as polymerized 2,2,4-trimethyl-1,2-dihydroquinoline; monophenolic antioxidants such as 2,6-di-t-butyl-4-methylphenol and styrenated phenol; and bis-, tris-, or polyphenolic antioxidants such as tetrakis[methylene-3-(3′,5′-di-t-butyl-4′-hydroxyphenyl)propionate]methane. Usable commercial products are available from Seiko Chemical Co., Ltd., Sumitomo Chemical Co., Ltd., Ouchi Shinko Chemical Industrial Co., Ltd., Flexsys, etc. These may be used alone or in combinations of two or more.

The amount of antioxidants per 100 parts by mass of the rubber component in the groove-forming rubber composition is preferably 0.5 parts by mass or more, more preferably 1.5 parts by mass or more, still more preferably 2.0 parts by mass or more, further preferably 3.0 parts by mass or more, while it is preferably 10.0 parts by mass or less, more preferably 6.0 parts by mass or less, still more preferably 4.0 parts by mass or less. When the amount is within the range indicated above, the advantageous effect tends to be better achieved.

The groove-forming rubber composition may contain a wax.

Non-limiting examples of the wax include petroleum waxes such as paraffin waxes and microcrystalline waxes and synthetic waxes such as polymers of ethylene, propylene, or other similar monomers. Usable commercial products are available from Ouchi Shinko Chemical Industrial Co., Ltd., Nippon Seiro Co., Ltd., Seiko Chemical Co., Ltd., etc. These may be used alone or in combinations of two or more.

The amount of waxes per 100 parts by mass of the rubber component in the groove-forming rubber composition is preferably 1 part by mass or more, more preferably 2 parts by mass or more, while it is preferably 10 parts by mass or less, more preferably 6 parts by mass or less. When the amount is within the range indicated above, the advantageous effect tends to be better achieved.

The groove-forming rubber composition may contain stearic acid.

The stearic acid may be conventional one. Usable commercial products are available from NOF Corporation, Kao Corporation, FUJIFILM Wako Pure Chemical Corporation, Chiba Fatty Acid Co., Ltd., etc. These may be used alone or in combinations of two or more.

The amount of stearic acid per 100 parts by mass of the rubber component in the groove-forming rubber composition is preferably 0.5 parts by mass or more, more preferably 0.8 parts by mass or more, still more preferably 1.0 parts by mass or more, further preferably 2.0 parts by mass or more, while it is preferably 10.0 parts by mass or less, more preferably 6.0 parts by mass or less. When the amount is within the range indicated above, the advantageous effect tends to be better achieved.

The groove-forming rubber composition may contain zinc oxide.

The zinc oxide may be a conventionally known one. Usable commercial products are available from Mitsui Mining & Smelting Co., Ltd., Toho Zinc Co., Ltd., Hakusui Tech Co., Ltd., Seido Chemical Industry Co., Ltd., Sakai Chemical Industry Co., Ltd., etc. These may be used alone or in combinations of two or more.

The amount of zinc oxide per 100 parts by mass of the rubber component in the rubber composition is preferably 0.5 parts by mass or more, more preferably 1.0 parts by mass or more, still more preferably 2.0 parts by mass or more, further preferably 2.2 parts by mass or more, while it is preferably 10.0 parts by mass or less, more preferably 6.0 parts by mass or less. When the amount is within the range indicated above, the advantageous effect tends to be better achieved.

The groove-forming rubber composition may contain sulfur.

Examples of the sulfur include those commonly used as crosslinking agents in the rubber industry, such as powdered sulfur, precipitated sulfur, colloidal sulfur, insoluble sulfur, highly dispersible sulfur, and soluble sulfur. Usable commercial products are available from Tsurumi Chemical Industry Co., Ltd., Karuizawa sulfur Co., Ltd., Shikoku Chemicals Corporation, Flexsys, Nippon Kanryu Industry Co., Ltd., Hosoi Chemical Industry Co., Ltd., etc. These may be used alone or in combinations of two or more.

The amount of sulfur per 100 parts by mass of the rubber component in the groove-forming rubber composition is preferably 0.5 parts by mass or more, more preferably 0.8 parts by mass or more, still more preferably 1.0 parts by mass or more, while it is preferably 3.5 parts by mass or less, more preferably 3.0 parts by mass or less, still more preferably 2.8 parts by mass or less. When the amount is within the range indicated above, the advantageous effect tends to be better achieved.

The groove-forming rubber composition may contain a vulcanization accelerator.

Examples of the vulcanization accelerator include thiazole vulcanization accelerators such as 2-mercaptobenzothiazole and di-2-benzothiazolyl disulfide; thiuram vulcanization accelerators such as tetramethylthiuram disulfide (TMTD) and tetrakis(2-ethylhexyl) thiuram disulfide (TOT-N); sulfenamide vulcanization accelerators such as N-cyclohexyl-2-benzothiazylsulfenamide (CBS), N-tert-butyl-2-benzothiazolylsulfenamide (TBBS), N-oxyethylene-2-benzothiazole sulfenamide, and N,N′-diisopropyl-2-benzothiazole sulfenamide; and guanidine vulcanization accelerators such as diphenylguanidine, diorthotolylguanidine, and orthotolylbiguanidine. Usable commercial products are available from Sumitomo Chemical Co., Ltd., Ouchi Shinko Chemical Industrial Co., Ltd., etc. These may be used alone or in combinations of two or more.

The amount of vulcanization accelerators per 100 parts by mass of the rubber component in the groove-forming rubber composition is preferably 1.0 parts by mass or more, more preferably 1.5 parts by mass or more, still more preferably 2.0 parts by mass or more, further preferably 3.9 parts by mass or more, while it is preferably 10.0 parts by mass or less, more preferably 7.0 parts by mass or less, still more preferably 5.0 parts by mass or less. When the amount is within the range indicated above, the advantageous effect tends to be better achieved.

In addition to the above-described components, the groove-forming rubber composition may further contain additives commonly used in the tire industry, such as organic peroxides. The amount of each additive is preferably 0.1 to 200 parts by mass per 100 parts by mass of the rubber component.

The groove-forming rubber composition may be prepared, for example, by kneading the above-described components using a rubber kneading machine such as an open roll mill or a Banbury mixer and then vulcanizing the kneaded mixture.

The kneading conditions are as follows. In a base kneading step of kneading additives other than vulcanizing agents and vulcanization accelerators, the kneading temperature is usually 100° C. to 180° C., preferably 120° C. to 170° C. In a final kneading step of kneading vulcanizing agents and vulcanization accelerators, the kneading temperature is usually 120° C. or lower, preferably 80° C. to 115° C., more preferably 85° C. to 110° C. Then, the composition obtained after kneading vulcanizing agents and vulcanization accelerators is usually vulcanized by, for example, press vulcanization. The vulcanization temperature is usually 140° C. to 190° C., preferably 150° C. to 185° C. The vulcanization time is usually 5 to 15 minutes.

### <Tire>

The tire of the present disclosure includes a tread with at least one circumferential groove, and a ratio Z (D/T) of the largest groove depth D (mm) of the circumferential groove to the largest thickness T (mm) of the tread satisfies the following formula (2):

Z≥0.10 (2)

where D represents the largest groove depth (mm) of the circumferential groove, T represents the largest thickness of the tread, and Z presents the ratio D/T.

The lower limit of the Z is preferably 0.21 or higher, more preferably 0.30 or higher, still more preferably 0.50 or higher, further preferably 0.60 or higher, particularly preferably 0.70 or higher. The upper limit is preferably 1.00 or lower, more preferably 0.95 or lower, still more preferably 0.90 or lower, further preferably 0.85 or lower, particularly preferably 0.84 or lower. When the Z is within the range indicated above, the advantageous effect tends to be better achieved.

In the tire of the present disclosure, the largest groove depth D of the circumferential groove formed on the tread is preferably 2.0 mm or more, more preferably 3.0 mm or more, still more preferably 6.0 mm or more, further preferably 7.0 mm or more, particularly preferably 8.0 mm or more. The upper limit is preferably 19.0 mm or less, more preferably 12.0 mm or less, still more preferably 11.0 mm or less, further preferably 10.0 mm or less, particularly preferably 9.0 mm or less. When the largest groove depth is within the range indicated above, the advantageous effect tends to be better achieved.

Herein, the largest groove depth D of the circumferential groove refers to a distance measured along the normal of a plane extended from a ground contact face defining the outermost surface of the tread. The largest groove depth is a distance from the plane extended from the ground contact face to the deepest bottom, and it is the largest distance among the groove depths of the circumferential grooves provided.

In the tire of the present disclosure, the largest thickness T of the tread is preferably 3.0 mm or more, more preferably 5.0 mm or more, still more preferably 7.0 mm or more, further preferably 9.0 mm or more, further preferably 9.5 mm or more. The upper limit is preferably 20.0 mm or less, more preferably 18.0 mm or less, still more preferably 16.0 mm or less, particularly preferably 14.0 mm or less. When the largest thickness is within the range indicated above, the advantageous effect tends to be better achieved.

Herein, the largest thickness T of the tread refers to a distance measured along the normal of a plane extended from a ground contact face defining the outermost surface of the tread. The largest thickness T is the largest distance among the distances from the plane extended from the ground contact face to the upper face of a carcass in the tire radial direction.

In the tire of the present disclosure, the tread preferably has a negative ratio S (%) of 95% or lower.

The S is preferably 90% or lower, more preferably 80% or lower, still more preferably 75% or lower, further preferably 70% or lower. The negative ratio is preferably 40% or higher, more preferably 45% or higher, still more preferably 50% or higher. When the negative ratio is within the range indicated above, the advantageous effect tends to be better achieved.

Here, the negative ratio (negative ratio within the ground contact surface of the tread portion) refers to the ratio of the total groove area within the ground contact surface to the total area of the ground contact surface and is determined as described below.

Herein, when the tire is a pneumatic tire, the negative ratio is calculated from the contact patch of the tire under conditions including a normal rim, a normal internal pressure, and a normal load. In the case of a non-pneumatic tire, the negative ratio can be similarly determined without the need of the normal internal pressure.

The term “normal rim” refers to a rim specified for each tire by the standard in a standard system including standards according to which tires are provided, and may be, for example, the “standard rim” in JATMA, “design rim” in TRA, or “measuring rim” in ETRTO.

The term “normal internal pressure” refers to an air pressure specified for each tire by the standard and may be the maximum air pressure in JATMA, the maximum value shown in Table “TIRE LOAD LIMITS AT VARIOUS COLD INFLATION PRESSURES” in TRA, or the “inflation pressure” in ETRTO.

The normal internal pressure for a passenger car tire is set to 180 kPa.

The term “normal load” refers to a load specified for each tire by the standard and may be a load calculated by multiplying either of the maximum load capacity in JATMA, the maximum value shown in Table “TIRE LOAD LIMITS AT VARIOUS COLD INFLATION PRESSURES” in TRA, or the “load capacity” in ETRTO by 0.88.

The contact patch may be determined by mounting the tire on a normal rim, applying a normal internal pressure to the tire, allowing the tire to stand at 25° C. for 24 hours, applying black ink to the tread surface of the tire, and pressing the tread surface against a cardboard at a normal load (camber angle: 0°) for transfer to the cardboard. The transfer is performed in five positions while rotating the tire by 12° each in the circumferential direction. Namely, the contact patch is obtained five times.

The average of the largest lengths in the tire axial direction of the five contact patches is denoted as L, and the average of the lengths in the direction orthogonal to the axial direction thereof is denoted as W.

The negative ratio (%) is calculated by the expression: [1−(Average of areas of five contact patches transferred to cardboard (parts with black ink))/(L×W)]×100(%).

Here, the average length and the average area are each the simple average of the five values.

The tire of the present disclosure includes a tread with at least one circumferential groove, and the circumferential groove is formed of a groove-forming rubber composition containing a rubber component and silica. In order to better achieve the advantageous effect, the tan δ when wet with water and the tan δ when dry of the groove-forming rubber composition and a ratio Z (D/T) of the largest groove depth D (mm) of the circumferential groove to the largest thickness T (mm) of the tread desirably satisfy the following formula:

(tan δ when wet with water/tan δ when dry)×Z≥0.10

where tan δ represents a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes, D represents the largest groove depth (mm) of the circumferential groove, T represents the largest thickness of the tread, and Z represents the ratio D/T.

The value of “(tan δ when wet with water/tan δ when dry)×Z” is preferably 0.24 or more, more preferably 0.30 or more, still more preferably 0.50 or more, further preferably 0.80 or more, further preferably 0.88 or more, further preferably 0.90 or more, further preferably 0.94 or more, further preferably 0.97 or more, further preferably 1.00 or more, further preferably 1.01 or more. The upper limit is preferably 1.71 or less, more preferably 1.50 or less, still more preferably 1.20 or less, further preferably 1.10 or less, further preferably 1.09 or less, further preferably 1.03 or less, further preferably 1.02 or less. When the value is within the range indicated above, the advantageous effect tends to be better achieved.

The tire of the present disclosure includes a tread with at least one circumferential groove, and the circumferential groove is formed of a groove-forming rubber composition containing a rubber component and silica. In order to better achieve the advantageous effect, the tan δ when wet with water of the groove-forming rubber composition and the negative ratio S(%) of the tread desirably satisfy the following formula:

tan δ when wet with water/S≥0.0018

where tan δ represents a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes, and S represents the negative ratio of the tread.

The value of “tan δ when wet with water/S” is preferably 0.0020 or more, more preferably 0.0023 or more, still more preferably 0.0024 or more, further preferably 0.0026 or more, further preferably 0.0028 or more, further preferably 0.0029 or more. The upper limit is preferably 0.0086 or less, more preferably 0.0050 or less, still more preferably 0.0037 or less, particularly preferably 0.0033 or less. When the value is within the range indicated above, the advantageous effect tends to be better achieved.

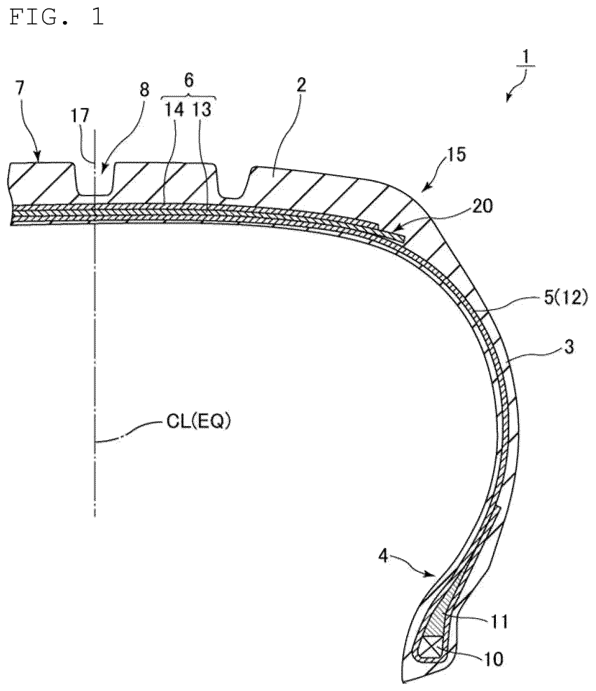

FIG. 1 shows a meridional cross-sectional view of a part of a pneumatic tire 1 according to an embodiment of the present disclosure. The tire of the present disclosure is not limited to the embodiment below.

In FIG. 1, the vertical direction corresponds to the radial direction of the tire (hereinafter, also referred to simply as radial direction), the horizontal direction corresponds to the axial direction of the tire (hereinafter, also referred to simply as axial direction), and the direction perpendicular to the paper corresponds to the circumferential direction of the tire (hereinafter, also referred to simply as circumferential direction). The tire 1 has a shape that is horizontally substantially symmetrical about a crown center 17 (center line CL) in FIG. 1. The center line CL is also referred to as a tread center line and defines the equator EQ of the tire 1.

The tire 1 includes a tread 2, a sidewall 3, a bead 4, a carcass 5, and a belt 6. The tire 1 is a tubeless tire.

The tread 2 includes a tread face 7. The tread face 7 has a radially outwardly convex shape in a cross-section taken in the meridional direction of the tire 1. The tread face 7 will contact the road surface. The tread face 7 has a plurality of circumferentially extending grooves 8 carved therein. The grooves 8 define a tread pattern. The external part of the tread 2 in the tire axial direction (tire width direction) is referred to as a shoulder portion 15. The sidewall 3 extends substantially inwardly in the radial direction from the end of the tread 2. The sidewall 3 consists of a cross-linked rubber or the like.

As shown in FIG. 1, the bead 4 is located radially substantially inward from the sidewall 3. The bead 4 includes a core 10 and an apex 11 radially outwardly extending from the core 10. The core 10 has a ring shape along the circumferential direction of the tire. The core 10 consists of a wound inextensible wire. Typically, a steel wire is used in the core 10. The apex 11 is radially outwardly tapered. The apex 11 consists of a very hard cross-linked rubber or the like.

In the present embodiment, the carcass 5 consists of a carcass ply 12. The carcass ply 12 extends between the opposite beads 4 along the inner sides of the tread 2 and the sidewalls 3. The carcass ply 12 is folded around the core 10 from the inside to the outside in the axial direction of the tire. Though not shown, the carcass ply 12 consists of a large number of parallel cords and a topping rubber. The absolute value of the angle of each cord relative to the equator EQ (CL) is usually 70° to 90°. In other words, the carcass 5 has a radial structure.

In the present embodiment, the belt 6 is located radially outward of the carcass 5. The belt 6 is stacked on the carcass 5. The belt 6 reinforces the carcass 5. The belt 6 may consist of an inner layer belt 13 and an outer layer belt 14. In the present embodiment, the widths of the belts 13 and 14 are different from each other.

Though not shown, the inner layer belt 13 and the outer layer belt 14 each usually consist of a large number of parallel cords and a topping rubber. Each cord is desirably inclined to the equator EQ. Desirably, the cords of the inner layer belt 13 are inclined in a direction opposite to that of the cords of the outer layer belt.

Though not shown, an embodiment may be used in which a band is stacked on the outer side of the belt 6 in the radial direction of the tire. The width of the band is larger than that of the belt 6. The band may consist of cords and a topping rubber. The cords are spirally wound. The belt is constrained by the cords, so that the belt 6 is inhibited from lifting. The cords desirably consist of organic fibers. Preferred examples of the organic fibers include nylon fibers, polyester fibers, rayon fibers, polyethylene naphthalate fibers, and aramid fibers.

Though not shown, an embodiment may be used in which an edge band is provided radially outward of the belt 6 and near the widthwise end (edge portion) of the belt 6. Like the band, the edge band may consist of cords and a topping rubber. An exemplary edge band may be stacked on the upper face of a step 20 of the wider inner layer belt 13. In an exemplary embodiment, the cords of the edge band are inclined in the same direction as the cords of the narrower outer layer belt 14 and are biased relative to the cords of the wider inner layer belt 13.

Though not shown, an embodiment may be used in which a cushion rubber layer is stacked on the carcass 5 near the widthwise end of the belt 6. In an exemplary embodiment, the cushion layer consists of a soft cross-linked rubber. The cushion layer absorbs the stress on the belt edge.

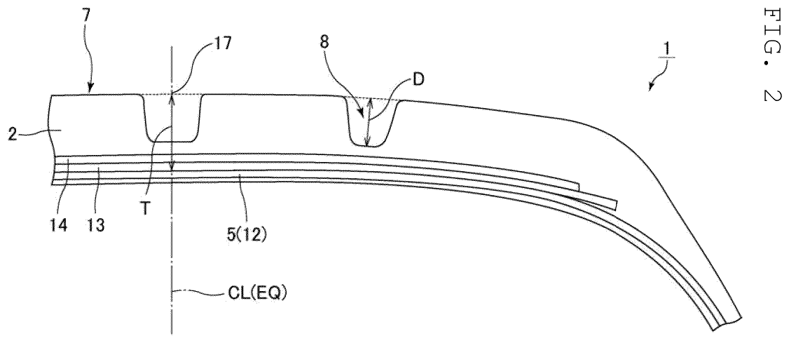

FIG. 2 shows a cross-sectional view of the tread 2 of the tire 1 cut along a plane including the tire axis.

In the tire 1, the tread rubber composition (vulcanized rubber composition) in the tread 2 consists of the above-described groove-forming rubber composition. The tan δ when wet with water and the tan δ when dry of the tread rubber composition (vulcanized rubber composition) satisfy the formula (1).

The tread 2 of the tire 1 is provided with circumferential grooves 8. In the tire 1, the largest groove depth D of the circumferential grooves 8 refers to a distance in the normal direction from a plane extended from a ground contact face defining the tread face 7 to the deepest bottom, and it is the depth of the deepest one of the multiple circumferential grooves 8.

In the tire 1, the largest thickness T of the tread 2 refers to the largest distance among the dimensions in the tire radial direction from a plane extended from a ground contact face defining the tread face 7 to the upper face of the carcass 5. The Z defined by “largest groove depth D/largest thickness T” satisfies the formula (2).

### EXAMPLES

Examples (working examples) which are considered preferable to implement the present disclosure are described below. Yet, the scope of the disclosure is not limited to the examples.

Compositions prepared using the chemicals listed below according to the formulation varied as shown in Table 1 and the tire specification shown in Table 1 are considered. The results calculated as described in the evaluation methods described below are shown in Table 1.
SBR: Nipol 1502 (E-SBR) available from ZEON Corporation
BR: BR730 (high-cis polybutadiene, cis content: 96% by mass) available from JSR Corporation
NR: TSR20
Carboxylic acid-modified SBR: synthesized in Production Example 1 below (carboxylic acid group content: 5% by mass, styrene content: 23% by mass, butadiene content: 72% by mass)
Carbon black: DIABLACK I (N220, N₂SA: 114 m²/g, DBP: 114 ml/100 g) available from Mitsubishi Chemical Corporation
Silica: ULTRASIL VN3 (N₂SA: 175 m²/g) available from Evonik Degussa
Ionic coupling agent: X-12-1126 (quaternary ammonium salt) available from Shin-Etsu Chemical Co., Ltd.
Silane coupling agent: Si69 (bis(3-triethoxysilylpropyl)tetrasulfide) available from EVONIK-DEGUSSA
Maleic acid-modified liquid polyisoprene: LIR-410 (Mw: 30000) available from Kuraray
Maleic anhydride-modified liquid polyisoprene: LIR-403 (Mn: 34000) available from Kuraray
Unmodified liquid polyisoprene: LIR-50 (Mw: 54000) available from Kuraray
Magnesium oxide: Kyowamag 150 (apparent specific gravity: 0.36 g/ml, d50: 4.46 pam, N₂SA: 145 m²/g) available from Kyowa Chemical Industry
Basic molecule: KBE-903 (3-aminopropyl triethoxysilane) available from Shin-Etsu Chemical Co., Ltd.
Stearic acid: stearic acid “TSUBAKI” available from NOF Corporation
Zinc oxide: zinc oxide #2 available from Mitsui Mining & Smelting Co., Ltd.
Oil: VIVATEC 400/500 (TDAE oil) available from H&R
Resin: SYLVARES SA85 (a copolymer of α-methylstyrene and styrene, Tg: 43° C., softening point: 85° C.) available from Arizona chemical
Wax: Ozoace 0355 available from Nippon Seiro Co., Ltd.
Antioxidant: Antigen 6C (N-(1,3-dimethylbutyl)-N′-phenyl-p-phenylenediamine) available from Sumitomo Chemical Co., Ltd.
Sulfur: powdered sulfur available from Tsurumi Chemical Industry Co., Ltd.
Vulcanization accelerator DPG: NOCCELER D (diphenyl guanidine) available from Ouchi Shinko Chemical Industrial Co., Ltd.
Vulcanization accelerator NS: NOCCELER NS (N-tert-butyl-2-benzothiazylsulfenamide (TBBS)) available from Ouchi Shinko Chemical Industrial Co., Ltd.

### Production Example 1: Synthesis of Carboxylic Acid-Modified SBR

### (Preparation of Latex)

An amount of 2000 g of distilled water, 45 g of emulsifier (1), 1.5 g of emulsifier (2), 8 g of an electrolyte, 250 g of styrene, 50 g of methacrylic acid, 700 g of polybutadiene, and 2 g of a molecular weight regulator are charged into a pressure-resistant reactor provided with a stirrer.

The reactor temperature is set to 5° C. An aqueous solution containing 1 g of a radical initiator and 1.5 g of SFS dissolved therein and an aqueous solution containing 0.7 g of EDTA and 0.5 g of a catalyst dissolved therein are added to the reactor to initiate polymerization.

Five hours after the initiation of polymerization, 2 g of a polymerization terminator is added to stop the reaction, whereby latex is prepared.

### (Preparation of Rubber)

Unreacted monomers are removed from the latex by steam distillation.

Then, the latex is added to alcohol and coagulated while the pH is adjusted to 3 to 5 with a saturated sodium chloride aqueous solution or formic acid to give a crumb polymer.

The polymer is dried with a vacuum dryer at 40° C. to obtain a solid rubber (emulsion polymerized rubber).

Materials used in Production Example 1 are as follows.
Emulsifier (1): rosin acid soap available from Harima Chemicals Group, Inc.
Emulsifier (2): fatty acid soap available from FUJIFILM Wako Pure Chemical Corporation
Electrolyte: sodium phosphate available from FUJIFILM Wako Pure Chemical Corporation
Styrene: styrene available from FUJIFILM Wako Pure Chemical Corporation
Methacrylic acid: methacrylic acid available from FUJIFILM Wako Pure Chemical Corporation
Butadiene: 1,3-butadiene available from Takachiho Chemical Industrial Co., Ltd.
Molecular weight regulator: tert-dodecylmercaptan available from FUJIFILM Wako Pure Chemical Corporation
Radical initiator: paramenthane hydroperoxide available from NOF Corporation
SFS: sodium formaldehyde sulfoxylate available from FUJIFILM Wako Pure Chemical Corporation
EDTA: sodium ethylenediaminetetraacetate available from FUJIFILM Wako Pure Chemical Corporation
Catalyst: ferric sulfate available from FUJIFILM Wako Pure Chemical Corporation
Polymerization terminator: N,N′-dimethyldithiocarbamate available from FUJIFILM Wako Pure Chemical Corporation
Alcohol: methanol, ethanol available from Kanto Chemical Co., Inc.
Formic acid: formic acid available from Kanto Chemical Co., Inc.
Sodium chloride: sodium chloride available from FUJIFILM Wako Pure Chemical Corporation

### Examples and Comparative Examples

According to the formulation shown in Table 1, the chemicals other than the sulfur and the vulcanization accelerators are kneaded in a 16-L Banbury mixer (Kobe Steel, Ltd.) at 160° C. for four minutes to obtain a kneaded mixture.

Next, the kneaded mixture is kneaded with the sulfur and vulcanization accelerators using an open roll mill at 80° C. for four minutes to obtain an unvulcanized polymer composition.

The unvulcanized polymer composition is formed into the shape of a tread and assembled with other tire components on a tire building machine to build an unvulcanized tire. The unvulcanized tire is vulcanized at 170° C. for 12 minutes, whereby a test tire (specification: Table 1, size: 195/65R15) is produced.

The materials used (carboxylic acid-modified SBR, surface-modified silica) and the produced test tire are subjected to measurement of the physical properties and evaluation as described below. Comparative Example 1 is referenced as a reference comparative example in Table 1.

### <Reaction Rate of Basic Molecule>

According to the method below, unreacted basic molecules on each surface-modified silica are dissolved in water, and the reaction rate of the basic molecules is calculated by titration.

(1) Prepare a calibration curve for basic molecules.
(2) Disperse the surface-modified silica in water to dissolve unreacted basic molecules, and then perform titration.
(3) Calculate the amount of the unreacted basic molecules from the titration value and the calibration curve equation.
(4) Calculate the reaction rate based on the amount of the basic molecules used in the synthesis.

### <Carboxylic Acid Group Content>

The carboxylic acid group content of the carboxylic acid-modified SBR is determined by ¹H-NMR analysis.

### <Negative Ratio>

The negative ratio in the test tire is measured by the following method.

The contact patch of the tread of the test tire is determined by mounting the test tire on a normal rim, applying a normal internal pressure to the tire, allowing the tire to stand at 25° C. for 24 hours, applying black ink to the tread surface of the tire, and pressing the tread surface against a cardboard at a normal load (camber angle: 0°) for transfer to the cardboard.

The transfer is performed in five positions while rotating the tire by 72° each in the circumferential direction to obtain the contact patch five times.

The average of the largest lengths in the tire axial direction of the five contact patches is denoted as L, and the average of the lengths in the direction orthogonal to the axial direction thereof is denoted as W. Then, the negative ratio (%) is calculated by the equation below.

The average length and the average area are each the simple average of the five values.

$$Negative ratio ( \% ) = [ 1 - \{ Average of areas of five contact patches transferred to cardboard ( parts with black ink ) \} / ( L \times W ) ] \times 100$$

### <Viscoelastic Test>

A viscoelastic measurement sample having a length of 40 mm, a width of 3 mm, and a thickness of 0.5 mm is collected from the inside of a tread rubber layer in each test tire such that the longitudinal direction of the sample corresponds to the circumferential direction of the tire. The tan δ of the tread rubber is measured under the conditions of a temperature of 30° C., an initial strain of 10%, a dynamic strain of 1%, a frequency of 10 Hz, an elongation mode, and a measurement duration of 30 minutes using a RSA series machine available from TA Instruments. A measurement value is obtained after 30 minutes from the start of the measurement.

The thickness direction of the sample corresponds to the radial direction of the tire.

<Tan δ when Dry>

The viscoelastic measurement sample having a length of 40 mm, a width of 3 mm, and a thickness of 0.5 mm is dried at room temperature and normal pressure to a constant weight.

The loss tangent tan δ of the dried vulcanized polymer composition (rubber piece) is measured by the above-described method. The measured tan δ is determined as tan δ when dry.

<Tan δ when Wet with Water>

The viscoelastic measurement sample having a length of 40 mm, a width of 3 mm, and a thickness of 0.5 mm is immersed in 100 mL of water at 23° C. for two hours to obtain a vulcanized polymer composition when wet with water.

Viscoelasticity measurement is performed in water by the above-described method to measure the loss tangent tan δ of the obtained vulcanized polymer composition (rubber piece) when wet with water using an immersion measurement jig of the RSA. The measured loss tangent is determined as tan δ when wet with water.

The temperature of the water is 30° C.

### <Dry Grip Performance>

The test tire is mounted on every wheel of a front-engine, front-wheel-drive car of 2000 cc displacement made in Japan. Twenty test drivers independently drive the car 10 rounds on a course with a dry road surface, and the drivers consider to rate the braking performance on a dry road surface on a scale of one to five, followed by calculation.

A higher rating indicates better braking performance. The sum of the ratings of the twenty drivers is calculated and expressed as an index relative to the sum in the reference comparative example taken as 100. A higher index indicates better dry grip performance.

### <Wet Grip Performance>

The test tire is mounted on every wheel of a front-engine, front-wheel-drive car of 2000 cc displacement made in Japan. Twenty test drivers independently drive the car 10 rounds on a course with a wet road surface, and the drivers consider to rate the braking performance in a wet road surface region on a scale of one to five, followed by calculation.

A higher rating indicates better braking performance. The sum of the ratings of the twenty drivers is calculated and expressed as an index relative to the sum in the reference comparative example taken as 100. A higher index indicates better wet grip performance.

### <Overall Performance>

The overall performance in terms of wet performance and dry performance (expressed as a sum of two indices of the wet grip performance and the dry grip performance) is evaluated.

TABLE 1

| | | Comparative Example | | | | | Example | |
|---|---|---|---|---|---|---|---|---|
| | | 1 | 2 | 3 | 4 | 5 | 1 | 2 |
| Amount | SBR | 70 | 70 | 70 | 70 | 70 | 70 | 70 |
| (parts by | BR | 20 | 20 | 20 | 20 | 20 | 20 | 20 |
| mass) | NR | 10 | 10 | 10 | 10 | 10 | 10 | 10 |
| | Carboxylic acid-modified SBR | | | | | | | |
| | Carbon black | 10 | 10 | 10 | 10 | 10 | 10 | 10 |
| | Silica | 75 | 75 | 75 | 75 | 75 | 75 | 75 |
| | Ionic coupling agent | | | | 4.08 | 4.08 | 4.08 | 2.04 |
| | Silane coupling agent | 6 | 6 | 6 | | | | 3 |
| | Maleic acid-modified liquid | | | 10 | 10 | 10 | 10 | 5 |
| | polyisoprene | | | | | | | |
| | Maleic anhydride-modified | | | | | | | |
| | liquid polyisoprene | | | | | | | |
| | Unmodified liquid polyisoprene | | 10 | | | | | 5 |
| | Magnesium oxide | | | | | | | |
| | Basic molecule | | | | | | | |
| | Stearic acid | 2 | 2 | 2 | 2 | 2 | 2 | 2 |
| | Zinc oxide | 2.2 | 2.2 | 2.2 | 2.2 | 2.2 | 2.2 | 2.2 |
| | Oil | 10 | 10 | 10 | 10 | 10 | 10 | 10 |
| | Resin | | | | | | | |
| | Wax | 2 | 2 | 2 | 2 | 2 | 2 | 2 |
| | Antioxidant | 3 | 3 | 3 | 3 | 3 | 3 | 3 |
| | Sulfur | 1 | 1 | 1 | 1 | 1 | 1 | 1 |
| | Vulcanization accelerator DPG | 2.3 | 2.3 | 2.3 | 2.3 | 2.3 | 2.3 | 2.3 |
| | Vulcanization accelerator NS | 1.6 | 1.6 | 1.6 | 1.6 | 1.6 | 1.6 | 1.6 |
| Tire | Largest groove depth D (mm) of | 8 | 8 | 8 | 1 | 1 | 8 | 8 |
| specification | circumferential groove | | | | | | | |
| | Largest thickness T (mm) of | 9.5 | 9.5 | 9.5 | 9.5 | 20 | 9.5 | 9.5 |
| | tread | | | | | | | |
| | Z (=D/T) | 0.84 | 0.84 | 0.84 | 0.05 | 0.05 | 0.84 | 0.84 |
| | Negative ratio S (%) | 70 | 70 | 70 | 70 | 70 | 70 | 70 |
| Physical | tan δ when wet with water/ | 1.00 | 1.00 | 1.00 | 1.15 | 1.15 | 1.15 | 1.07 |
| properties/ | tan δ when dry | | | | | | | |
| Evaluation | tan δ when wet with water | 0.18 | 0.17 | 0.15 | 0.18 | 0.18 | 0.18 | 0.17 |
| | tan δ when dry | 0.18 | 0.17 | 0.15 | 0.16 | 0.16 | 0.16 | 0.16 |
| | (tan δ when wet with water/ | 0.84 | 0.84 | 0.84 | 0.06 | 0.06 | 0.97 | 0.90 |
| | tan δ when dry) × Z | | | | | | | |
| | tan δ when wet with water/S | 0.0026 | 0.0024 | 0.0021 | 0.0026 | 0.0026 | 0.0026 | 0.0024 |
| | (a) Dry grip performance | 100 | 100 | 100 | 115 | 90 | 100 | 100 |
| | (b) Wet grip performance | 100 | 100 | 100 | 80 | 80 | 115 | 110 |
| | Overall performance (=(a) + b)) | 200 | 200 | 200 | 195 | 170 | 215 | 210 |

| | | Example | | | | | |
|---|---|---|---|---|---|---|---|
| | | 3 | 4 | 5 | 6 | 7 | 8 |
| Amount | SBR | 70 | 70 | 70 | 70 | 70 | 70 |
| (parts by | BR | 20 | 20 | 20 | 20 | 20 | 20 |
| mass) | NR | 10 | 10 | 10 | 10 | 10 | 10 |
| | Carboxylic acid-modified SBR | | | | | | |
| | Carbon black | 10 | 10 | 10 | 10 | 10 | 10 |
| | Silica | 75 | 75 | 75 | 60 | 90 | 75 |
| | Ionic coupling agent | 4.08 | 4.08 | 4.08 | 4.08 | 4.08 | 4.08 |
| | Silane coupling agent | | | | | | |
| | Maleic acid-modified liquid | 10 | 10 | 10 | 10 | 10 | 20 |
| | polyisoprene | | | | | | |
| | Maleic anhydride-modified | | | | | | |
| | liquid polyisoprene | | | | | | |
| | Unmodified liquid polyisoprene | | | | | | |
| | Magnesium oxide | | | | | | |
| | Basic molecule | | | | | | |
| | Stearic acid | 2 | 2 | 2 | 2 | 2 | 2 |
| | Zinc oxide | 2.2 | 2.2 | 2.2 | 2.2 | 2.2 | 2.2 |
| | Oil | 10 | 10 | 10 | 10 | 10 | 10 |
| | Resin | | | | | | |
| | Wax | 2 | 2 | 2 | 2 | 2 | 2 |
| | Antioxidant | 3 | 3 | 3 | 3 | 3 | 3 |
| | Sulfur | 1 | 1 | 1 | 1 | 1 | 1 |
| | Vulcanization accelerator DPG | 2.3 | 2.3 | 2.3 | 2.3 | 2.3 | 2.3 |
| | Vulcanization accelerator NS | 1.6 | 1.6 | 1.6 | 1.6 | 1.6 | 1.6 |
| Tire | Largest groove depth D (mm) of | 19 | 19 | 2 | 8 | 8 | 8 |
| specification | circumferential groove | | | | | | |
| | Largest thickness T (mm) of | 20 | 20 | 9.5 | 9.5 | 9.5 | 9.5 |
| | tread | | | | | | |
| | Z (=D/T) | 0.95 | 0.95 | 0.21 | 0.84 | 0.84 | 0.84 |
| | Negative ratio S (%) | 70 | 90 | 70 | 70 | 70 | 70 |
| Physical | tan δ when wet with water/ | 1.15 | 1.15 | 1.15 | 1.12 | 1.20 | 1.22 |
| properties/ | tan δ when dry | | | | | | |
| Evaluation | tan δ when wet with water | 0.18 | 0.18 | 0.18 | 0.17 | 0.20 | 0.20 |
| | tan δ when dry | 0.16 | 0.16 | 0.16 | 0.15 | 0.17 | 0.16 |
| | (tan δ when wet with water/ | 1.09 | 1.09 | 0.24 | 0.94 | 1.01 | 1.03 |
| | tan δ when dry) × Z | | | | | | |
| | tan δ when wet with water/S | 0.0026 | 0.0020 | 0.0026 | 0.0024 | 0.0029 | 0.0028 |
| | (a) Dry grip performance | 90 | 95 | 115 | 95 | 105 | 100 |
| | (b) Wet grip performance | 115 | 110 | 90 | 110 | 125 | 125 |
| | Overall performance (=(a) + b)) | 205 | 205 | 205 | 205 | 230 | 225 |

| | | Example | | | | |
|---|---|---|---|---|---|---|
| | | 9 | 10 | 11 | 12 | 13 |
| Amount | SBR | 70 | 70 | | | 70 |
| (parts by | BR | 20 | 20 | 20 | 20 | 20 |
| mass) | NR | 10 | 10 | 10 | 10 | 10 |
| | Carboxylic acid-modified SBR | | | 70 | 70 | |
| | Carbon black | 10 | 10 | 10 | 10 | 10 |
| | Silica | 75 | 75 | 75 | 75 | 75 |
| | Ionic coupling agent | 4.08 | 4.08 | 4.08 | | 4.08 |
| | Silane coupling agent | | | | | |
| | Maleic acid-modified liquid | 30 | | | | 10 |
| | polyisoprene | | | | | |
| | Maleic anhydride-modified | | 10 | | | |
| | liquid polyisoprene | | | | | |
| | Unmodified liquid polyisoprene | | | | | |
| | Magnesium oxide | | | 2.2 | | |
| | Basic molecule | | | | 4.0 | |
| | Stearic acid | 2 | 2 | 2 | 2 | 2 |
| | Zinc oxide | 2.2 | 2.2 | 2.2 | 2.2 | 2.2 |
| | Oil | 10 | 10 | 10 | 10 | 10 |
| | Resin | | | | | 10 |
| | Wax | 2 | 2 | 2 | 2 | 2 |
| | Antioxidant | 3 | 3 | 3 | 3 | 3 |
| | Sulfur | 1 | 1 | 1 | 1 | 1 |
| | Vulcanization accelerator DPG | 2.3 | 2.3 | 2.3 | 2.3 | 2.3 |
| | Vulcanization accelerator NS | 1.6 | 1.6 | 1.6 | 1.6 | 1.6 |
| Tire | Largest groove depth D (mm) of | 8 | 8 | 8 | 8 | 8 |
| specification | circumferential groove | | | | | |
| | Largest thickness T (mm) of | 9.5 | 9.5 | 9.5 | 9.5 | 9.5 |
| | tread | | | | | |
| | Z (=D/T) | 0.84 | 0.84 | 0.84 | 0.84 | 0.84 |
| | Negative ratio S (%) | 70 | 70 | 70 | 70 | 70 |
| Physical | tan δ when wet with water/ | 1.21 | 1.15 | 1.05 | 1.05 | 1.15 |
| properties/ | tan δ when dry | | | | | |
| Evaluation | tan δ when wet with water | 0.19 | 0.18 | 0.18 | 0.18 | 0.18 |
| | tan δ when dry | 0.16 | 0.16 | 0.17 | 0.17 | 0.16 |
| | (tan δ when wet with water/ | 1.02 | 0.97 | 0.88 | 0.88 | 0.97 |
| | tan δ when dry) × Z | | | | | |
| | tan δ when wet with water/S | 0.0028 | 0.0026 | 0.0026 | 0.0026 | 0.0026 |
| | (a) Dry grip performance | 100 | 100 | 105 | 105 | 100 |
| | (b) Wet grip performance | 120 | 115 | 115 | 115 | 115 |
| | Overall performance (=(a) + b)) | 220 | 215 | 220 | 220 | 215 |

The present disclosure (1) relates to a tire, including a tread with at least one circumferential groove,
the circumferential groove being formed of a groove-forming rubber composition containing a rubber component and silica,
tan δ when wet with water and tan δ when dry of the groove-forming rubber composition and a ratio Z of a largest groove depth D (mm) of the circumferential groove to a largest thickness T (mm) of the tread satisfying the following formulas (1) and (2):

$$tan δ when wet with water / tan δ when dry > 1. \qquad ( 1 )$$

$$z \geq 0.1 \qquad ( 2 )$$

where tan δ represents a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes, and Z represents the ratio D/T.

The present disclosure (2) is the tire according to the present disclosure (1),
wherein the groove-forming rubber composition contains a modified polymer.

The present disclosure (3) is the tire according to the present disclosure (1) or (2),
wherein the groove-forming rubber composition contains an ionic coupling agent.

The present disclosure (4) is the tire according to the present disclosure (3),
wherein the ionic coupling agent has a salt structure.

The present disclosure (5) is the tire according to the present disclosure (4),
wherein the salt is a quaternary ammonium salt.

The present disclosure (6) is the tire according to any one of the present disclosures (2) to (4),
wherein the modified polymer contains at least one selected from the group consisting of a carboxylic acid group, a sulfonic acid group, a phosphoric acid group, and salts thereof in its molecule.

The present disclosure (7) is the tire according to any one of the present disclosures (1) to (6),
wherein the Z satisfies the following formula:

Z≥0.70

where Z represents the ratio D/T.

The present disclosure (8) is the tire according to any one of the present disclosures (1) to (7),
wherein the tread has a negative ratio S (%) of 75% or lower.

The present disclosure (9) is the tire according to any one of the present disclosures (1) to (8),
wherein the tan δ when wet with water and the tan δ when dry of the groove-forming rubber composition and the Z satisfy the following formula:

$$( tan δ when wet with water / tan δ when dry ) \times z \geq 0.9$$

where tan δ represents a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes, and Z represents the ratio D/T.

The present disclosure (10) is the tire according to the present disclosure (8) or (9),
wherein the tan δ when wet with water of the groove-forming rubber composition and the S satisfy the following formula:

tan δ when wet with water/S≥0.0024

where tan δ represents a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes, and S represents the negative ratio of the tread.

The present disclosure (11) is the tire according to any one of the present disclosures (1) to (10),
wherein the tan δ when wet with water and the tan δ when dry of the groove-forming rubber composition satisfy the following formula:

tan δ when wet with water/tan δ when dry≥1.05

where tan δ represents a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes.

The present disclosure (12) is the tire according to any one of the present disclosures (1) to (11),
wherein the tan δ when wet with water of the groove-forming rubber composition satisfies the following formula:

tan δ when wet with water≥0.17

where tan δ represents a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes.

The present disclosure (13) is the tire according to any one of the present disclosures (1) to (12),
wherein the tan δ when dry of the groove-forming rubber composition satisfies the following formula:

tan δ when dry≥0.15

where tan δ represents a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes.

The present disclosure (14) is the tire according to any one of the present disclosures (1) to (13),
wherein the largest groove depth D (mm) of the circumferential groove is 3.0 to 12.0 mm.

The present disclosure (15) is the tire according to any one of the present disclosures (1) to (14),
wherein the largest thickness T (mm) of the tread is 7.0 to 16.0 mm.

### REFERENCE SIGNS LIST

1 tire
2 tread
3 sidewall
4 bead
5 carcass
6 belt
7 tread face
8 groove
10 core
11 apex
12 carcass ply
13 inner layer belt
14 outer layer belt
15 shoulder portion
17 crown center (tread center line CL, equator EQ of tire 1)
20 step
D largest groove depth of circumferential groove
T largest thickness of tread

1. A tire, comprising a tread with at least one circumferential groove,
the circumferential groove being formed of a groove-forming rubber composition containing a rubber component and silica,
tan δ when wet with water and tan δ when dry of the groove-forming rubber composition and a ratio Z of a largest groove depth D (mm) of the circumferential groove to a largest thickness T (mm) of the tread satisfying the following formulas (1) and (2):
$$tan δ when wet with water / tan δ when dry > 1. \qquad ( 1 )$$
$$z \geq 0.1 \qquad ( 2 )$$
where tan δ represents a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes, and Z represents the ratio D/T.

2. The tire according to claim 1, wherein the groove-forming rubber composition comprises a modified polymer.

3. The tire according to claim 1, wherein the groove-forming rubber composition comprises an ionic coupling agent.

4. The tire according to claim 3, wherein the ionic coupling agent has a salt structure.

5. The tire according to claim 4, wherein the salt is a quaternary ammonium salt.

6. The tire according to claim 2, wherein the modified polymer comprises at least one selected from the group consisting of a carboxylic acid group, a sulfonic acid group, a phosphoric acid group, and salts thereof in its molecule.

7. The tire according to claim 1, wherein the Z satisfies the following formula: Z≥0.70
where Z represents the ratio Dfr.

8. The tire according to claim 1, wherein the tread has a negative ratio S (%) of 75% or lower.

9. The tire according to claim 1, wherein the tan δ when wet with water and the tan δ when dry of the groove-forming rubber composition and the Z satisfy the following formula:
(tan δ when wet with water/tan δ when dry)×Z≥20.90
where tan δ represents a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes, and Z represents the ratio D/T.

10. The tire according to claim 8,
wherein the tan δ when wet with water of the groove-forming rubber composition and the S satisfy the following formula:
tan δ when wet with water/S≥0.0024
where tan δ represents a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes, and S represents the negative ratio of the tread.

11. The tire according to claim 1, wherein the tan δ when wet with water and the tan δ when dry of the groove-forming rubber composition satisfy the following formula:
tan δ when wet with water/tan δ when dry≥1.05
where tan δ represents a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes.

12. The tire according to claim 1, wherein the tan δ when wet with water of the groove-forming rubber composition satisfies the following formula:
tan δ when wet with water≥0.17
where tan δ represents a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes.

13. The tire according to claim 1, wherein the tan δ when dry of the groove-forming rubber composition satisfies the following formula:
tan δ when dry≥0.15
where tan δ represents a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes.

14. The tire according to claim 1, wherein the largest groove depth D (mm) of the circumferential groove is 3.0 to 12.0 mm.

15. The tire according to claim 1, wherein the largest thickness T (mm) of the tread is 7.0 to 16.0 mm.
